(19) United States
(12) Patent Application Publication
(10) Pub. No.: US 2009/0138483 A1
(43) Pub. Date: May 28, 2009

(54) Method and System for Authoring and Distributing Downloadable Interactive Learning Activities

(75) Inventor: Peter H. Dublin, Cambridge, MA (US)

Correspondence Address: BROMBERG & SUNSTEIN LLP, 125 SUMMER STREET, BOSTON, MA, 02110-1618, US

(73) Assignee: MAESTRO LEARNING, INC., Watertown, MA (US)

(21) Appl. No.: 12/233,166

(22) Filed: Sep. 18, 2008

Related U.S. Application Data
(60) Provisional application No. 60/977,821, filed on Oct. 5, 2007.

(51) Int. Cl. G06F 17/30

(52) U.S. Cl. 707/10; 707/E17.032

(57) ABSTRACT

A method of authoring a downloadable interactive learning activity includes generating, by a first subsystem of an interactive learning activity authoring system, an interactive learning activity computer file. The interactive learning activity computer file is based on learning activity specifications received via a series of computer-based learning activity authoring forms. The method also includes storing, by a second subsystem of the interactive learning activity authoring system, the learning activity file and associated metadata in a database that is accessible via an online server.

### CROSS-REFERENCE TO RELATED APPLICATION(S)

This patent application claims priority from U.S. Provisional Patent Application No. 60/977,821 entitled Method and System for Authoring and Distributing Downloadable Interactive Learning Activities filed on Oct. 5, 2007 in the name of Peter H. Dublin, which is hereby incorporated herein by reference in its entirety.

### TECHNICAL FIELD

The present invention relates to interactive learning activities, and particularly to systems and methods for authoring and distributing downloadable interactive learning activities.

### BACKGROUND ART

In recent years, parents and teachers have begun to realize the importance of making learning fun and interactive for their children and students. As a result, many parents and teachers have turned to educational software, games, and activities that not only aid the educational development of the child, but also provide a fun and stimulating learning environment. Many of these educational software programs, games, and activities can be targeted to a specific age group or to the needs of a particular student or child.

Educational software programs and games are typically purchased on a CD-ROM, downloaded from a website as a bundle of games/programs similar to that purchased on the CD-ROM, or played from a web browser (e.g., as flash files that are stored temporarily in the web browser cache). Furthermore, authoring of such programs/games is typically separate from publishing/distribution of the programs/games. For example, an authoring program may be used to author programs/games, and a separate distribution program may be used to bundle the programs/games onto a CD-ROM for distribution or to otherwise publish the programs/games for online playing. Similarly, other types of media (e.g., music) are often accessed online, but, again, the authoring of content is typically separate from the publishing/distribution of such content.

### SUMMARY OF THE INVENTION

In accordance with one aspect of the invention there is provided a method of authoring a downloadable interactive learning activity. The method involves generating, by a first subsystem of an interactive learning activity authoring system, an interactive learning activity computer file based on learning activity specifications received via a series of computer-based learning activity authoring forms; and storing, by a second subsystem of the interactive learning activity authoring system, the learning activity file and associated metadata in a database that is accessible via an online server.

In accordance with another aspect of the invention there is provided a system for authoring a downloadable interactive learning activity. The system includes a first subsystem for generating an interactive learning activity computer file based on learning activity specifications received via a series of computer-based learning activity authoring forms; and a second subsystem for storing the learning activity and associated metadata in a database that is accessible via an online server.

In various alternative embodiments, computer-based learning activity authoring forms may be presented via a user interface, and learning activity specifications may be received via the user interface. The metadata may include at least one of grade level, subject, topic, skill, activity name, activity template family, activity template, language, public/private status, and price. An interactive activity player may be provided to permit authors to preview their interactive learning activities prior to publication.

In accordance with yet another aspect of the invention there is provided a method of distributing a downloadable interactive learning activity. The method involves providing access to a database of interactive learning activity computer files via an online server, the online server allowing a user to search for and selectively download interactive learning activity computer files based on metadata associated with the interactive learning activity computer files; and transmitting selected interactive learning activity computer files for storage on a user computer, whereby the downloaded interactive learning activity computer files can be played on the user computer without online access.

In accordance with still another aspect of the invention there is provided a system for distributing a downloadable interactive learning activity. The system includes a database of interactive learning activity computer files, wherein the database is accessible via an online server, the online server allowing a user to search for and selectively download interactive learning activity computer files based on metadata associated with the interactive learning activity computer files; and a download module for transmitting selected interactive learning activity computer files for storage on a user computer, whereby the downloaded interactive learning activity computer files can be played on the user computer without online access.

In various alternative embodiments, the metadata may include at least one of grade level, subject, topic, skill, activity name, activity template family, activity template, language, public/private status, and price. The download module may run on a web server. An interactive activity player may be provided to permit interactive learning activities to be played over a network.

### BRIEF DESCRIPTION OF THE DRAWINGS

The foregoing features of the invention will be more readily understood by reference to the following detailed description, taken with reference to the accompanying drawings, in which:

FIG. 1 schematically shows a general block diagram of a system for authoring a downloadable interactive learning activity in accordance with an embodiment of the present invention.

FIG. 2 shows a process diagram of a system in accordance with an embodiment of the present invention.

FIGS. 3A through 51A show various exemplary screen shots of authoring forms used by the system shown in FIG. 1, in accordance embodiments of the present invention.

FIGS. 3B through 51B show various exemplary screen shots of end-user interfaces created from the authoring forms shown in FIGS. 3A through 52A, in accordance embodiments of the present invention.

FIG. 52 shows a process diagram of a method of using the system of FIGS. 1 and 2, in accordance with embodiments of the present invention.

FIG. 53 shows an exemplary screen shot of a log in screen of the system of FIG. 1, in accordance with embodiments of the present invention.

FIGS. 54 and 55 show exemplary screen shots of a store screen of the system of FIG. 1, in accordance with embodiments of the present invention.

FIGS. 56 and 57 show exemplary screen shots of a library screen of the system of FIG. 1, in accordance with embodiments of the present invention.

### DETAILED DESCRIPTION OF SPECIFIC EMBODIMENTS

In embodiments of the present invention, a system for authoring and distributing downloadable interactive learning activities is provided. In certain embodiments, an integrated authoring/publishing tool is used for both authoring the interactive activity and publishing the interactive activity. For instance, a single application program within the system can create an interactive learning activity file from user-inputted specifications and then store this interactive learning activity file to a database that is accessible via an online server.

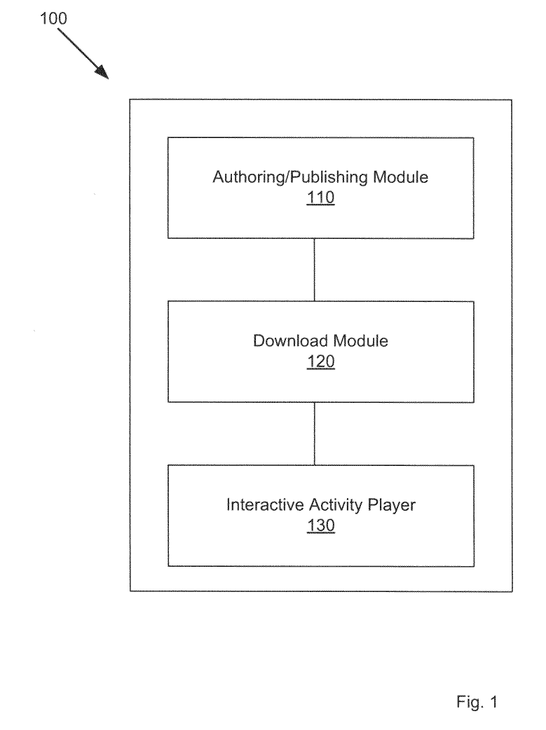

FIG. 1 is a schematic block diagram showing the relevant components of an authoring/distribution system 100 in accordance with an exemplary embodiment of the present invention. The system 100 may have a plurality of modules that facilitate the creation, publishing, downloading, and playing of interactive learning activities, including an integrated authoring publishing module 110, a download module 120, and interactive activity player module 130. Although these modules are shown as part of an overall system, it should be noted that the modules may run on different platforms within the overall system. Specifically, the authoring/publishing module 110 may run on an application computer that is accessible to authors of interactive learning activities (e.g., a company computer, a school computer, or a personal computer). The download module 120 may run on a web server. The interactive activity player 130 may run on a user computer. The authoring/publishing module 110 may include a version of the interactive activity player, for example to allow authors to preview their interactive learning activities prior to publication. A version of the player may also be included in the download module 120, for example, to allow the interactive learning activities to be played over a network such as the Internet.

As discussed briefly above, the system may include an authoring/publishing module 110 that, as the name suggests, serves the dual function of authoring and publishing the interactive learning activity. As described in greater detail, the authoring/publishing module 110 authors/creates the interactive learning activity based on specifications inputted by a user through one or more authoring forms. Once the authoring/publishing module 110 creates/authors the interactive learning activity, the same module (e.g., the authoring/publishing module 110) publishes the interactive learning activity computer file. Publishing the interactive learning activity computer file may include, but is not limited to, storing the learning activity along with appropriate metadata/attributes in a database that is accessible via an online server.

In accordance with some embodiments of the present invention, the system 100 may include subsystems within the authoring/publishing module that perform the above described functions. For example, an authoring subsystem can author/create the interactive learning activity file and a publishing subsystem can store the activity file to the database. However, it is important to note that, in such embodiments, the subsystems still remain part of the authoring/publishing module 110.

In addition to the authoring/publishing module 110, the system 110 may also include a download module 120 that allows a user to search the database and download selected files. As will be described in greater detail below, the authoring/publishing module 110 associates each of the interactive learning activity files with metadata and/or attribute information. The user and the download module 120 may use the associated metadata and attributes as search fields. In other words, when using the download module 120, the user can search for and selectively download interactive learning activity files based on the associated metadata. The associated metadata and attributes may include, but are not limited to, grade level, subject, topic, skill, activity name, activity template family, activity template, language, status (e.g., public or private), and price. Once the user has selected the interactive activities to download, the download module 120 may transmit the selected activity files to the user's computer.

In addition to the authoring/publishing module 110 and the download module 120, the system 100 may also include and interactive activity player 130 that allows the user to play/run the downloaded interactive activities on his or her own computer. In some embodiments, because the activity files are fully downloaded to the user's computer along with the interactive activity player 130, the user does not need online access to play the downloaded activities, so the activities are portable and can be played in a safe environment without internet access for children.

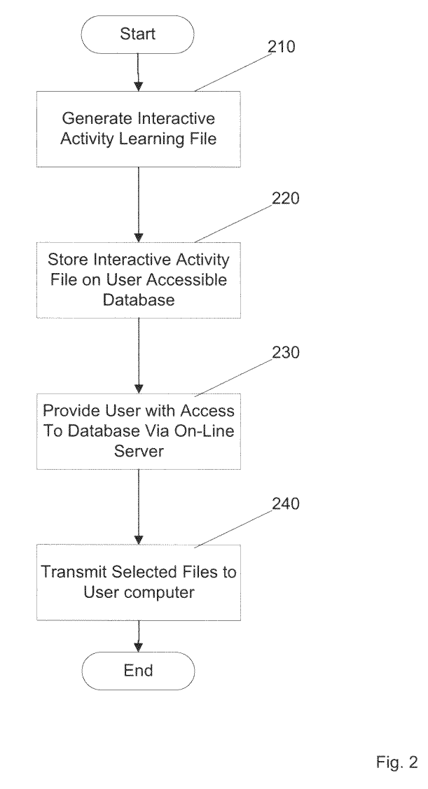

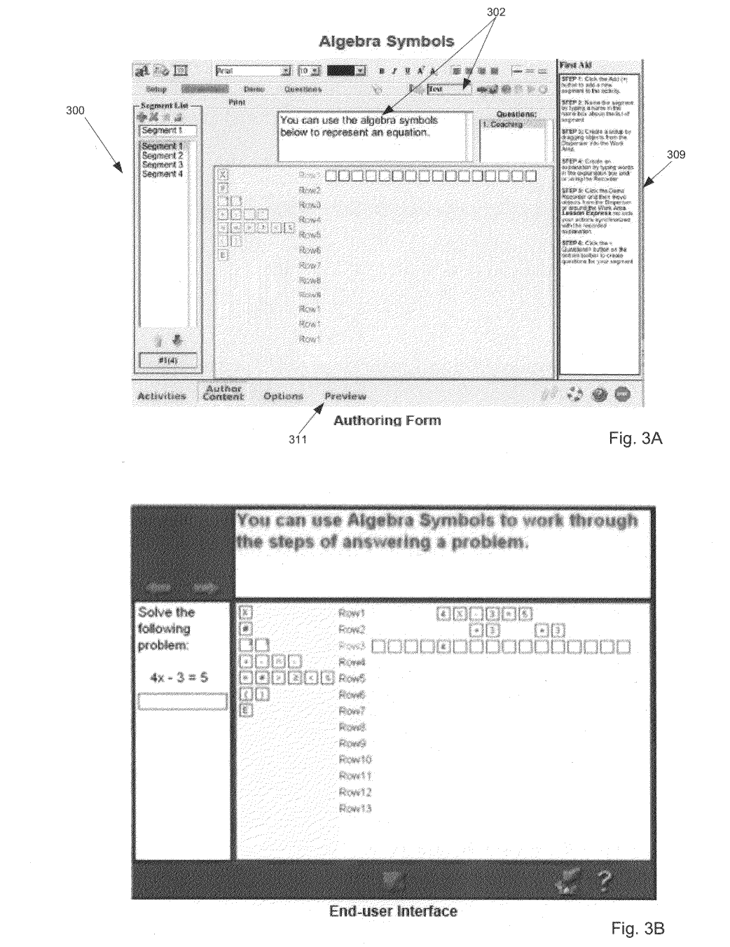

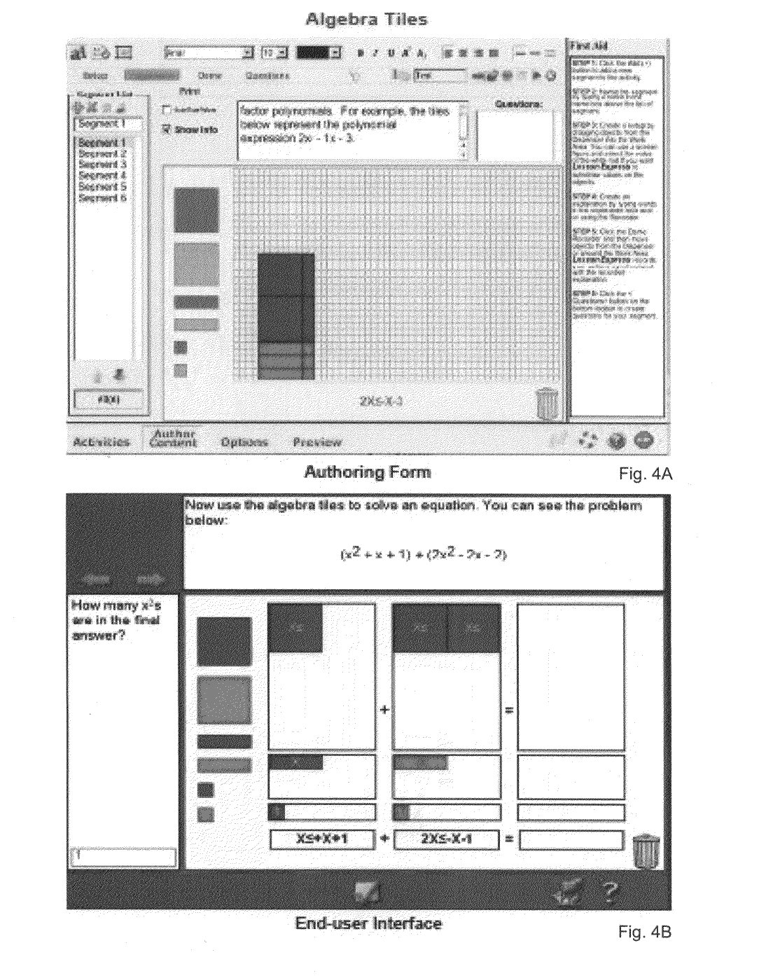

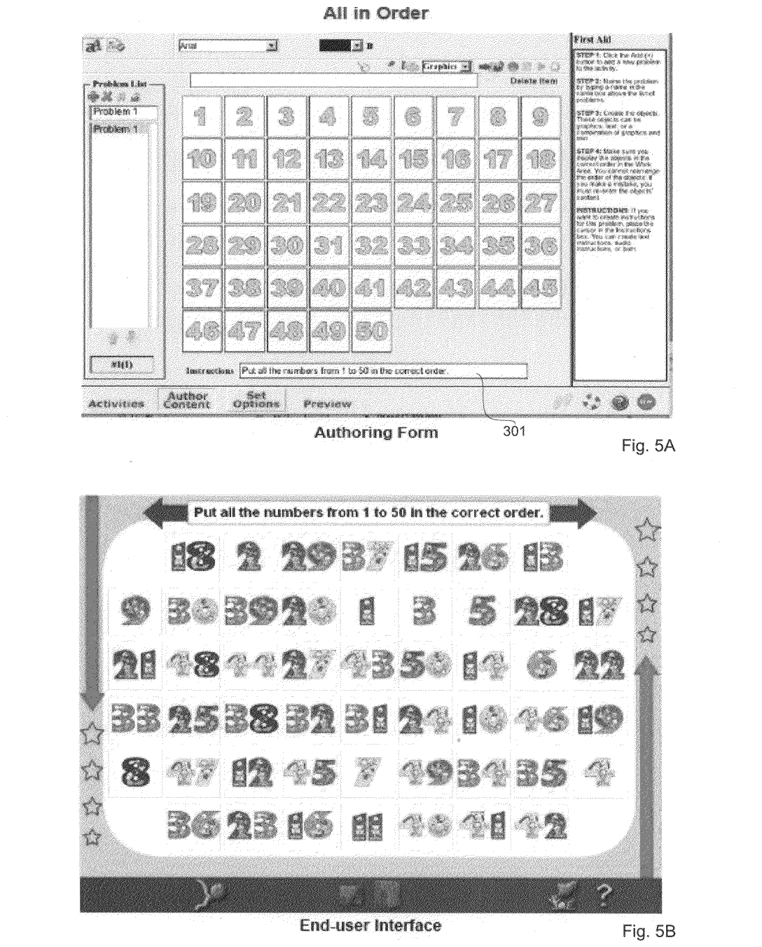

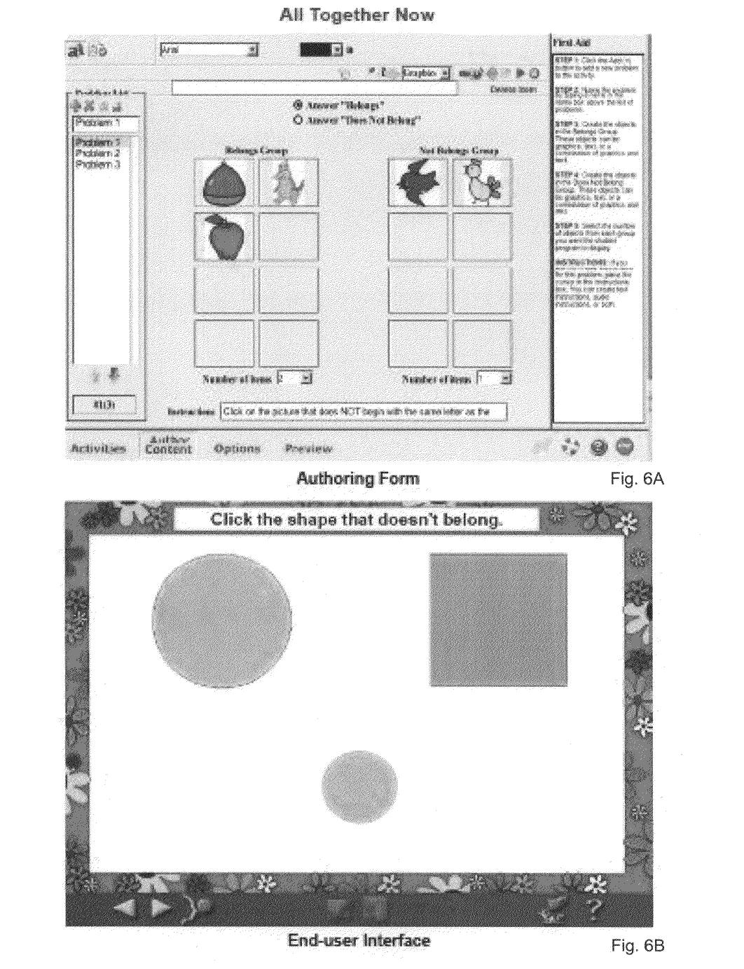

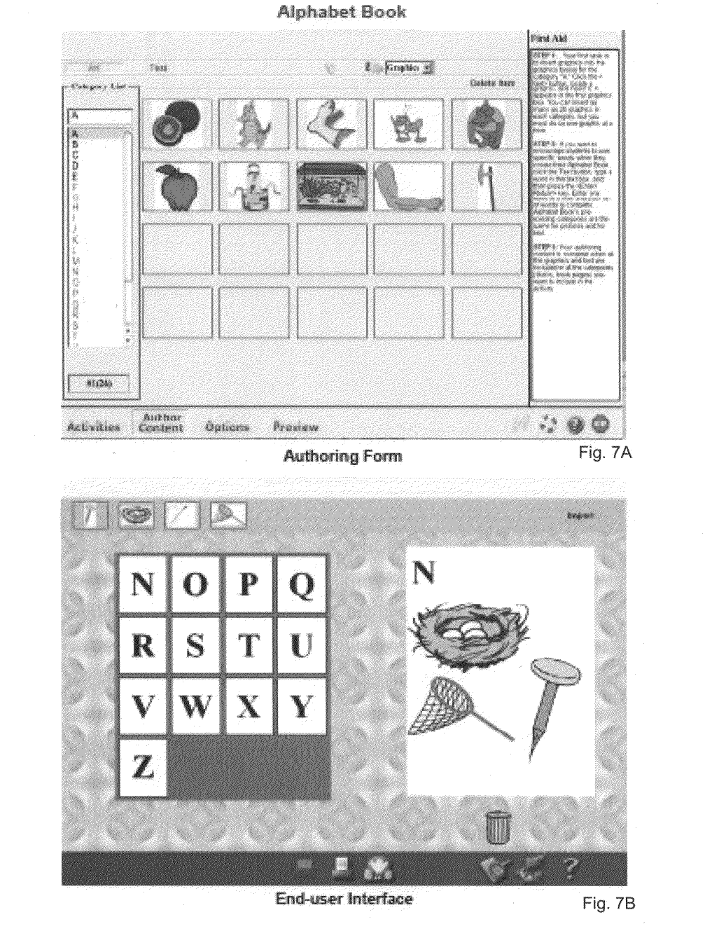

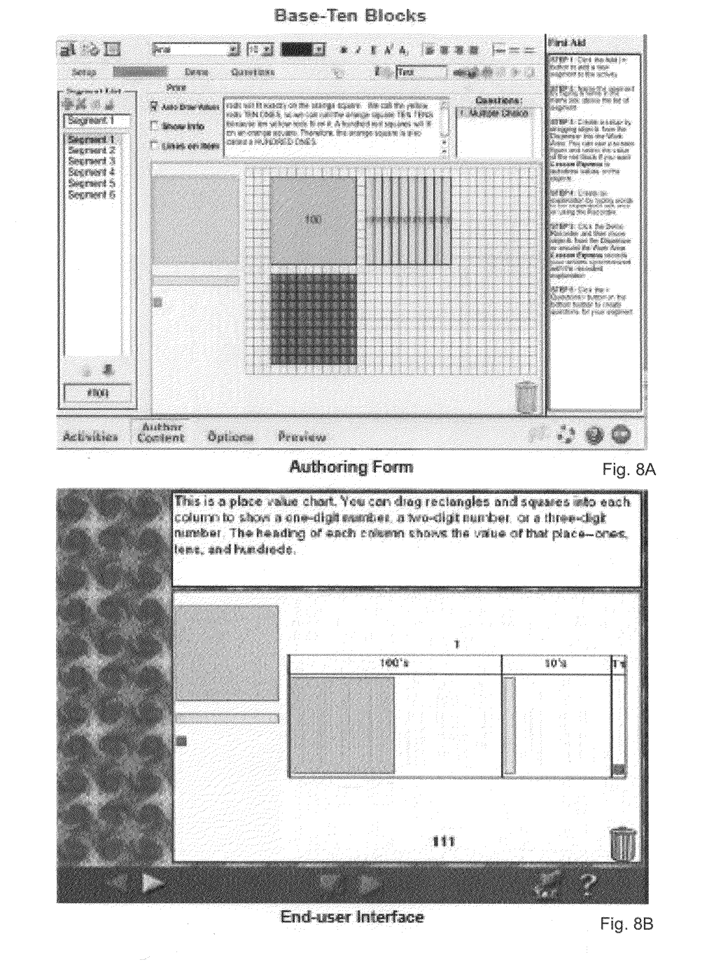

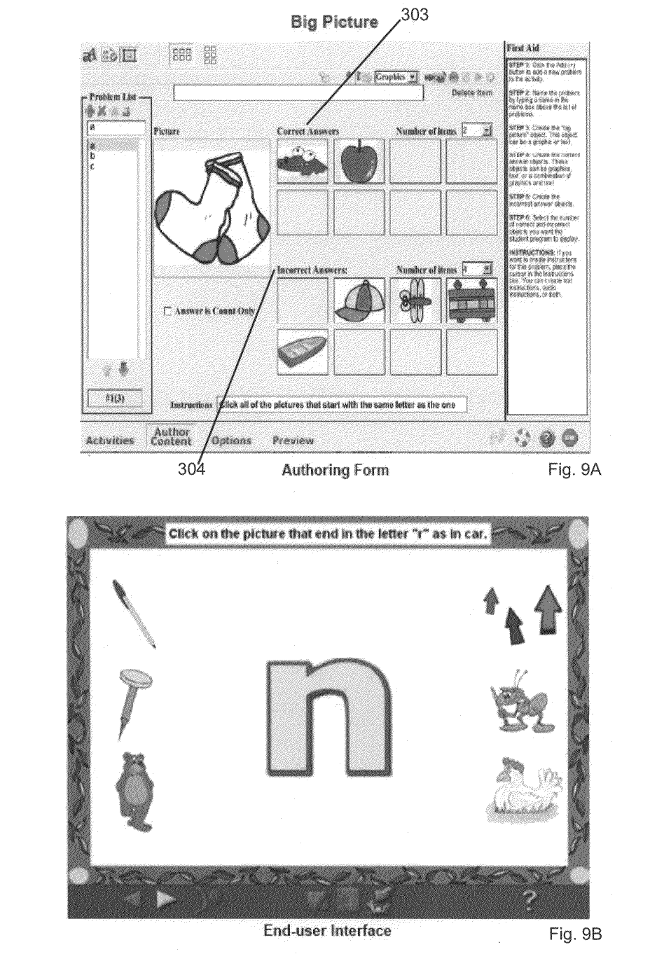

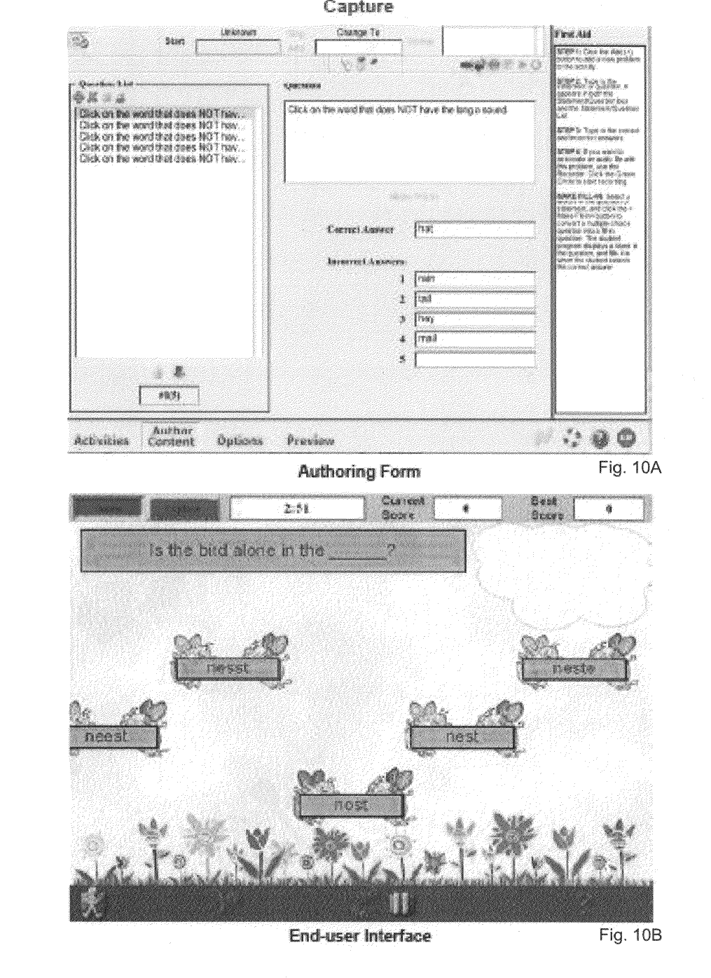

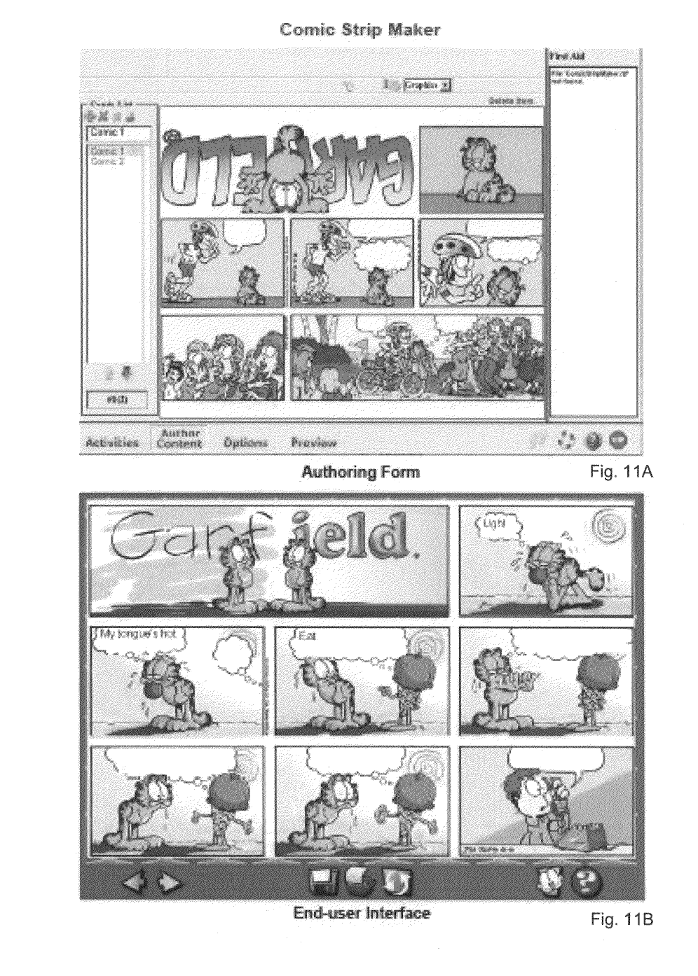

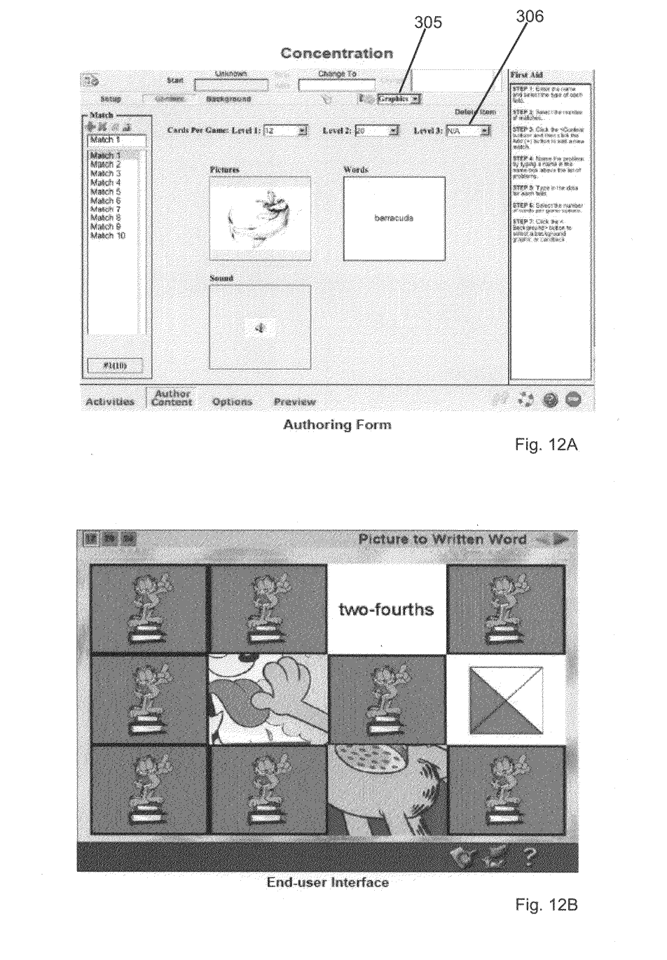

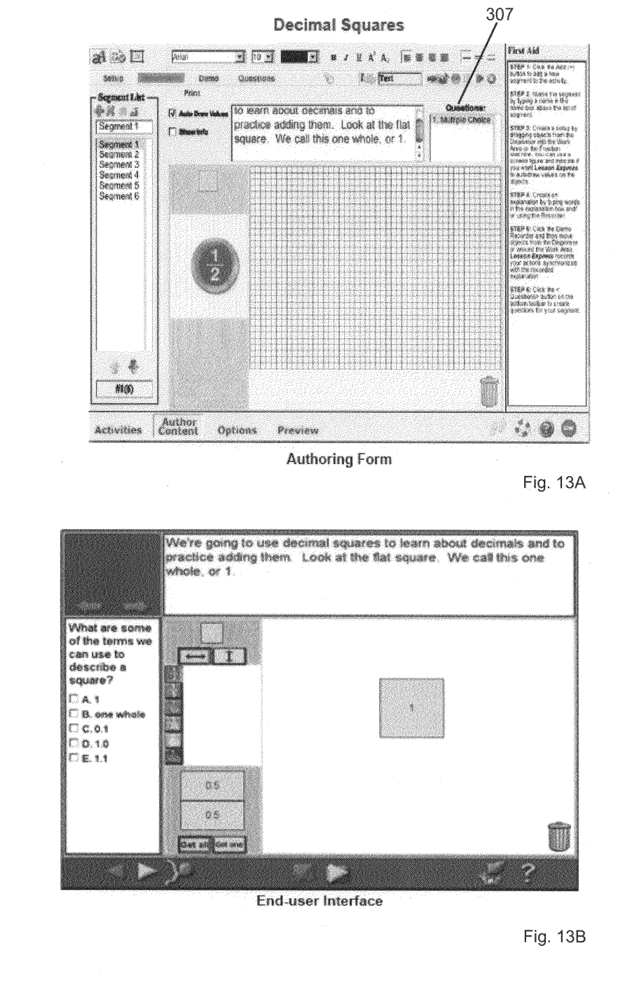

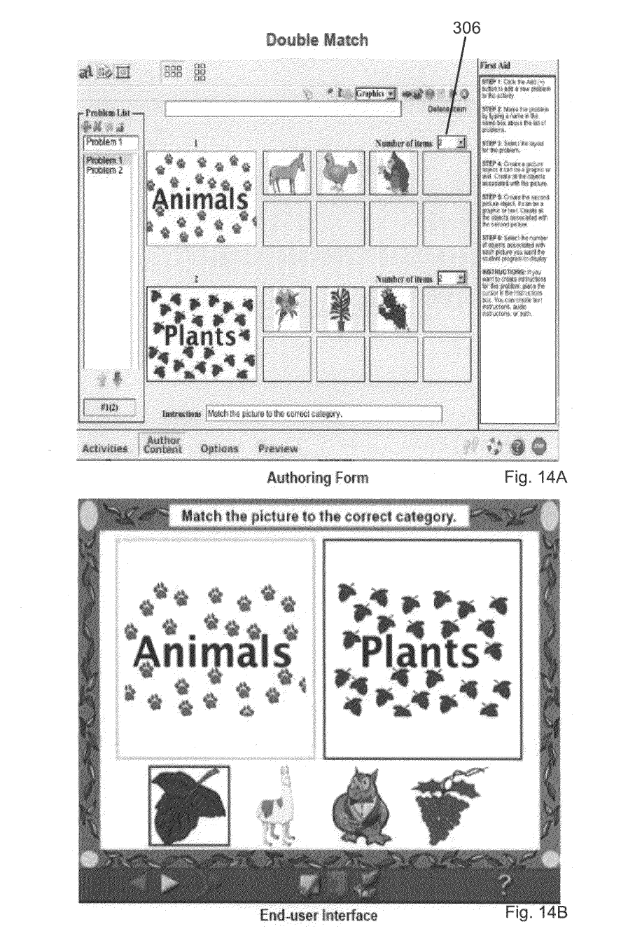

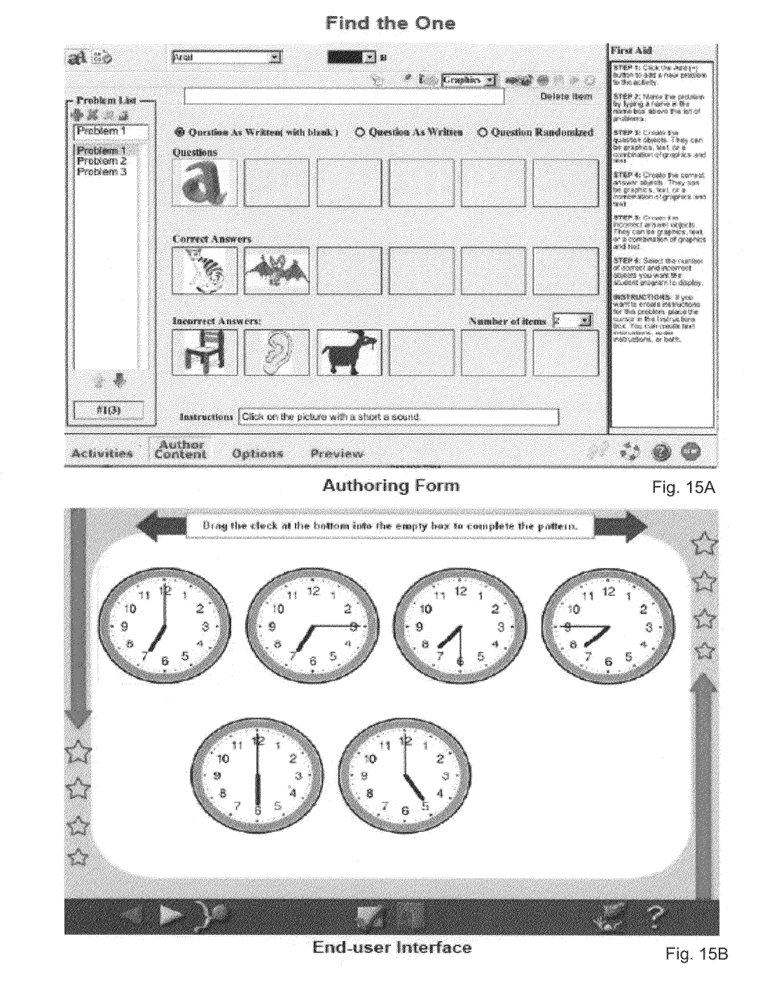

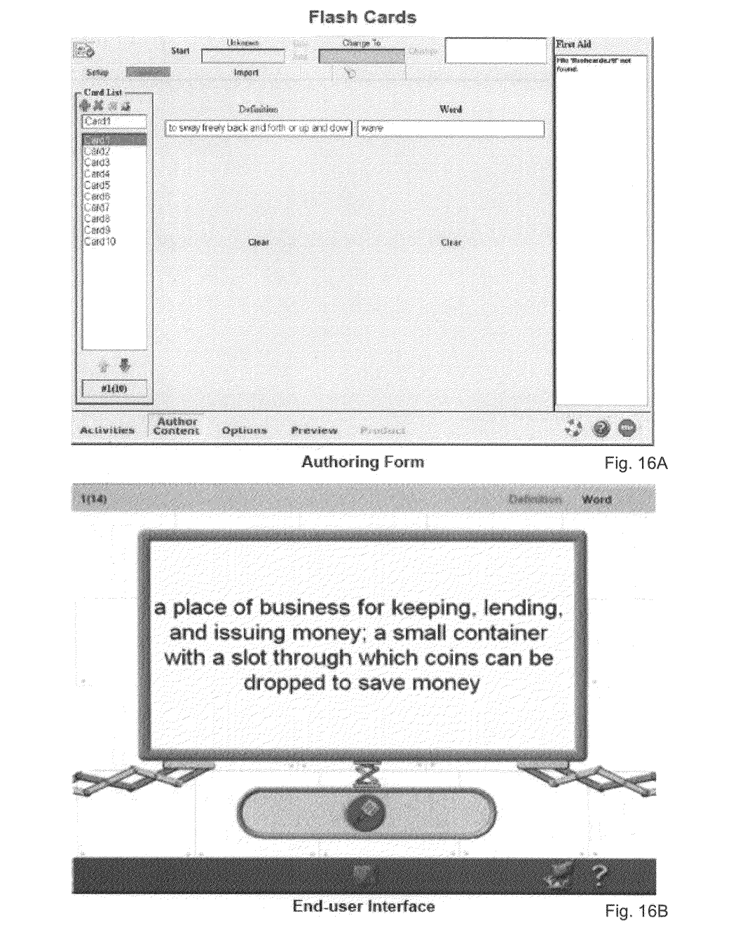

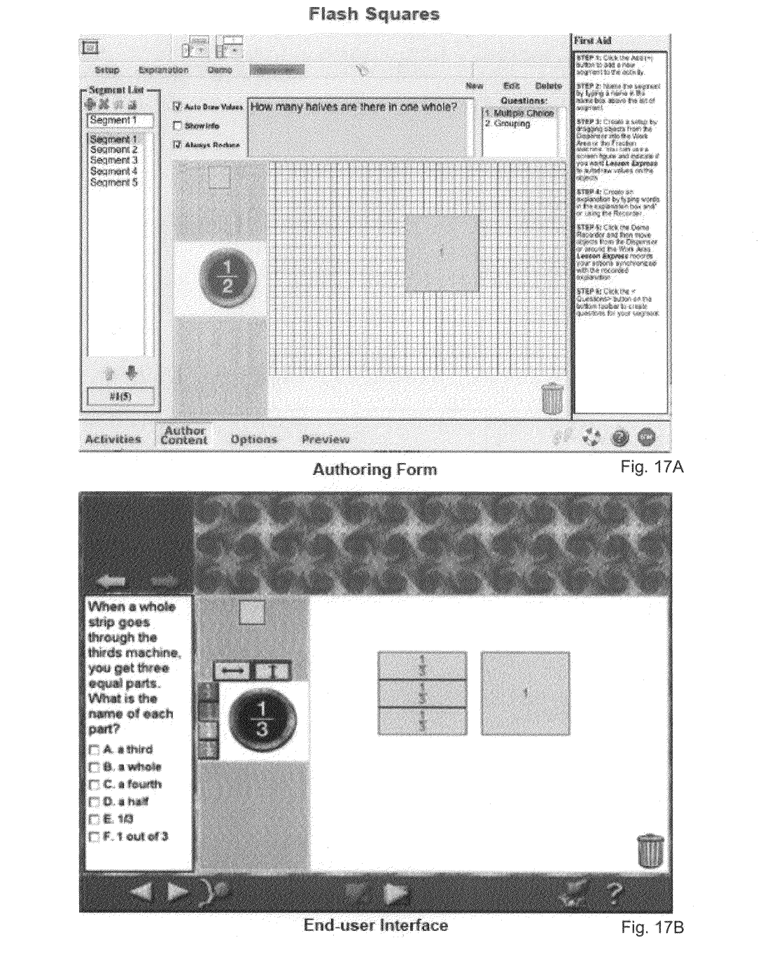

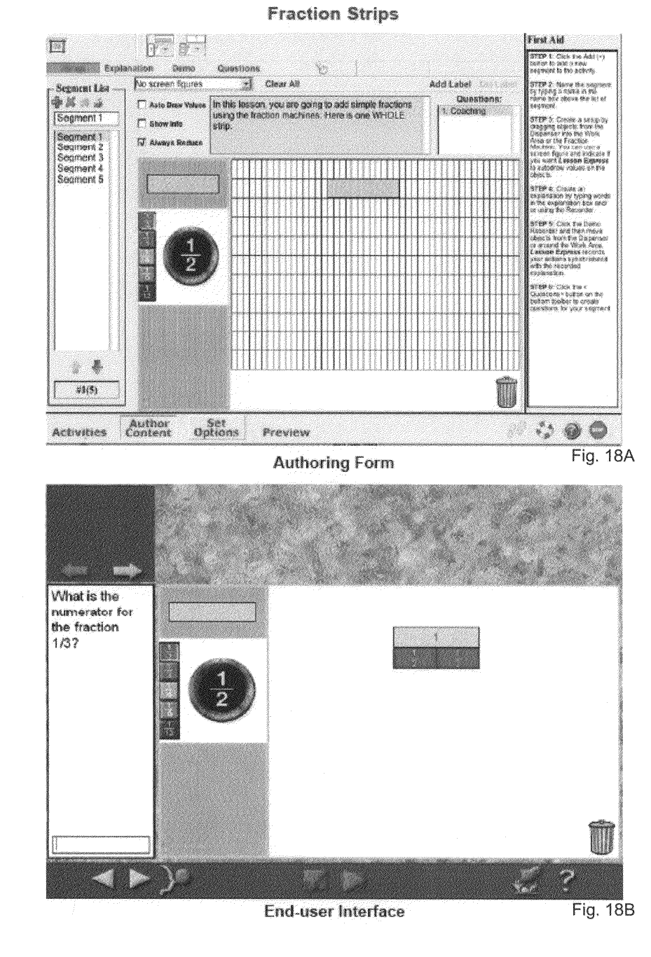

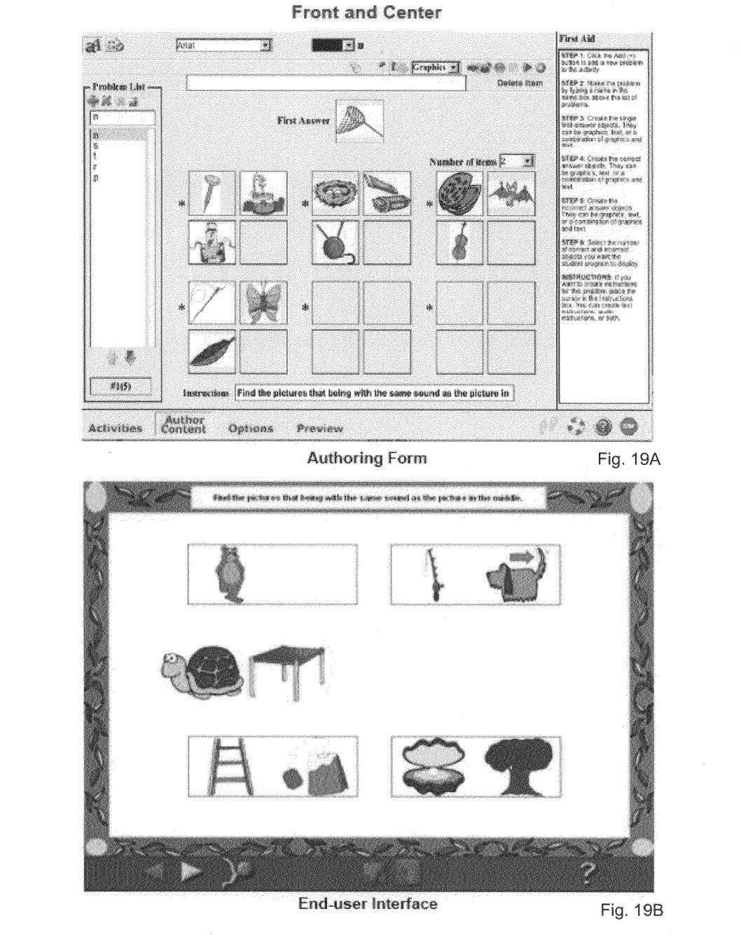

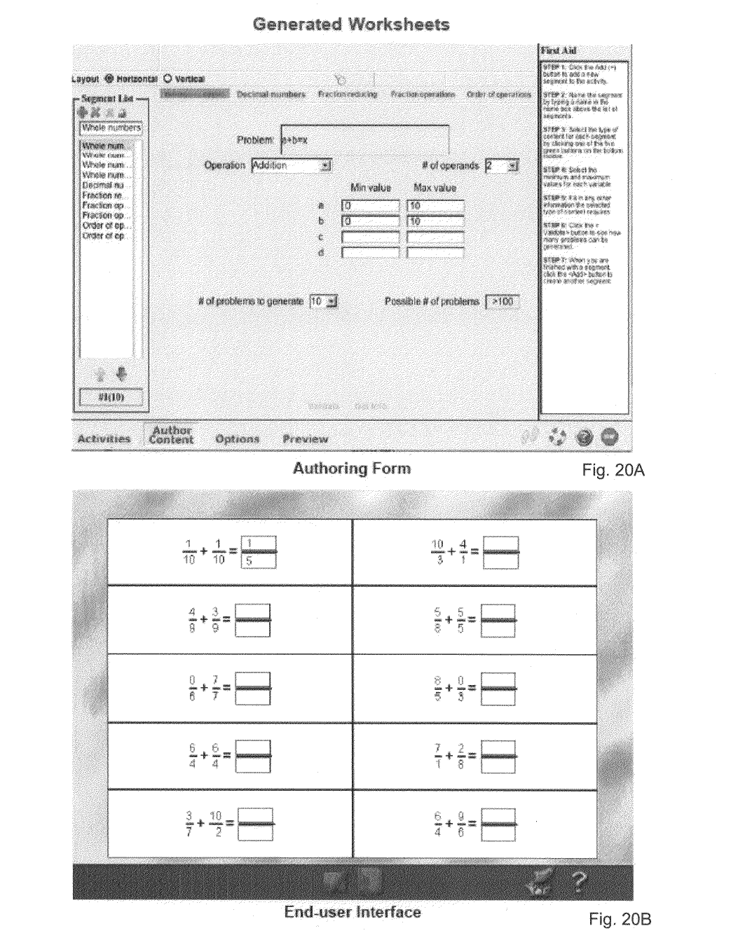

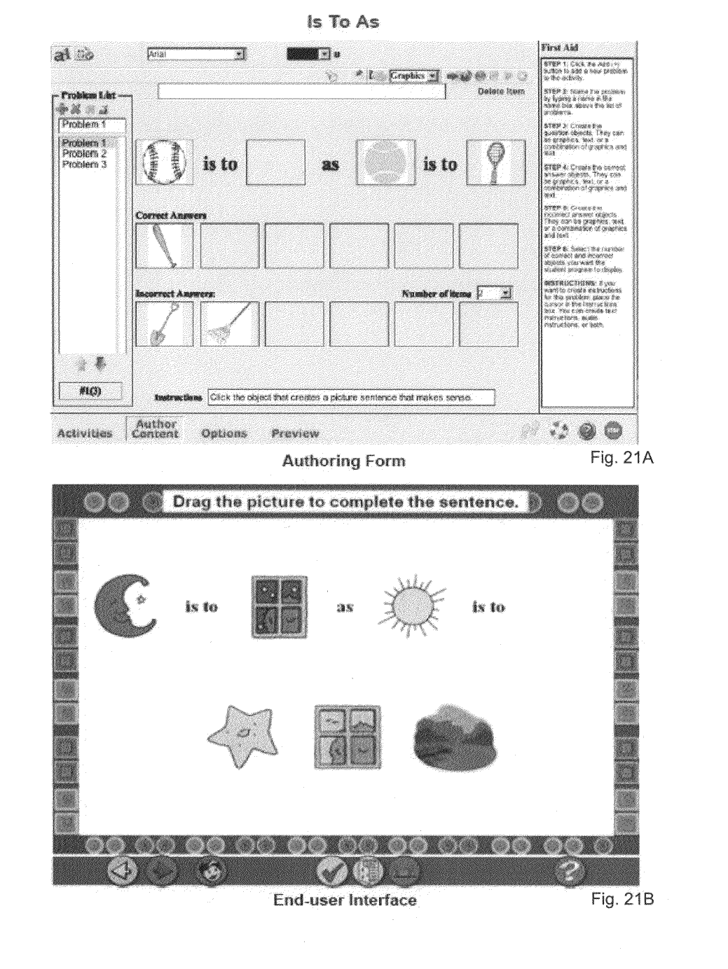

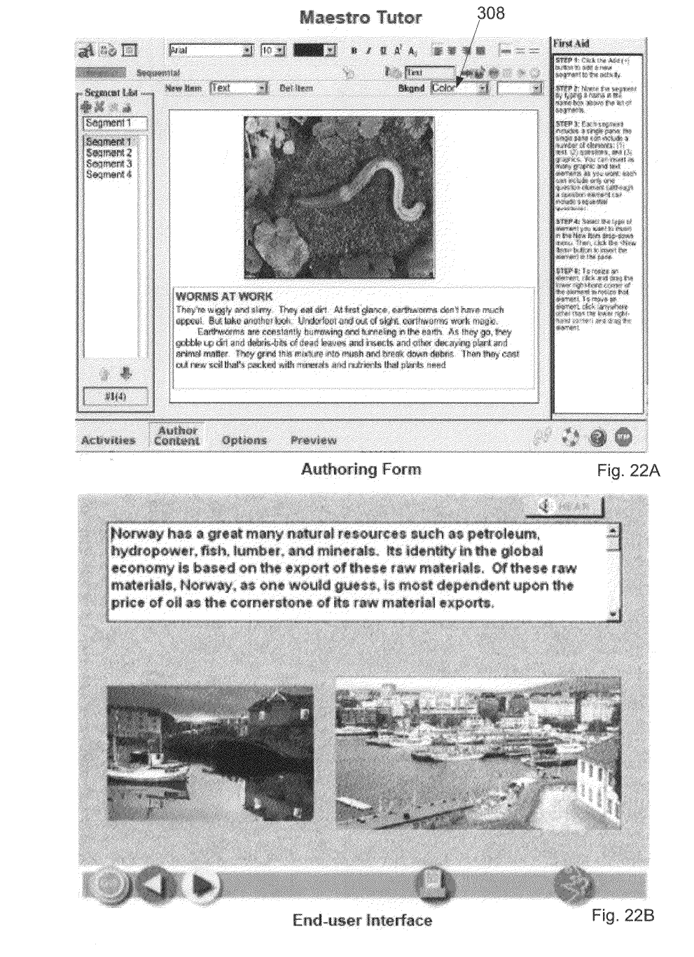

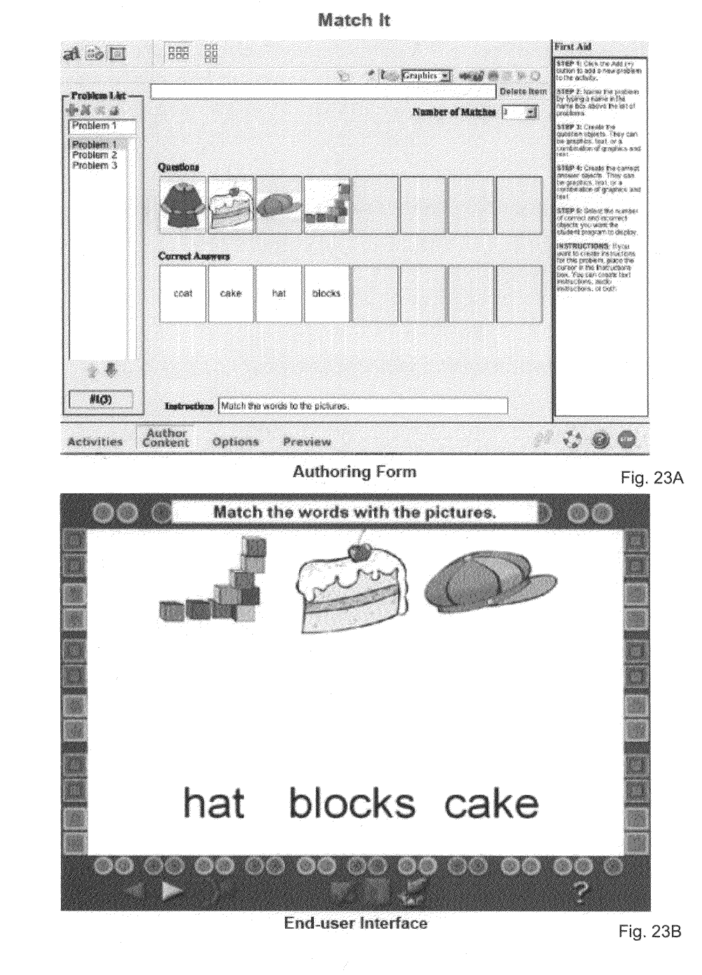

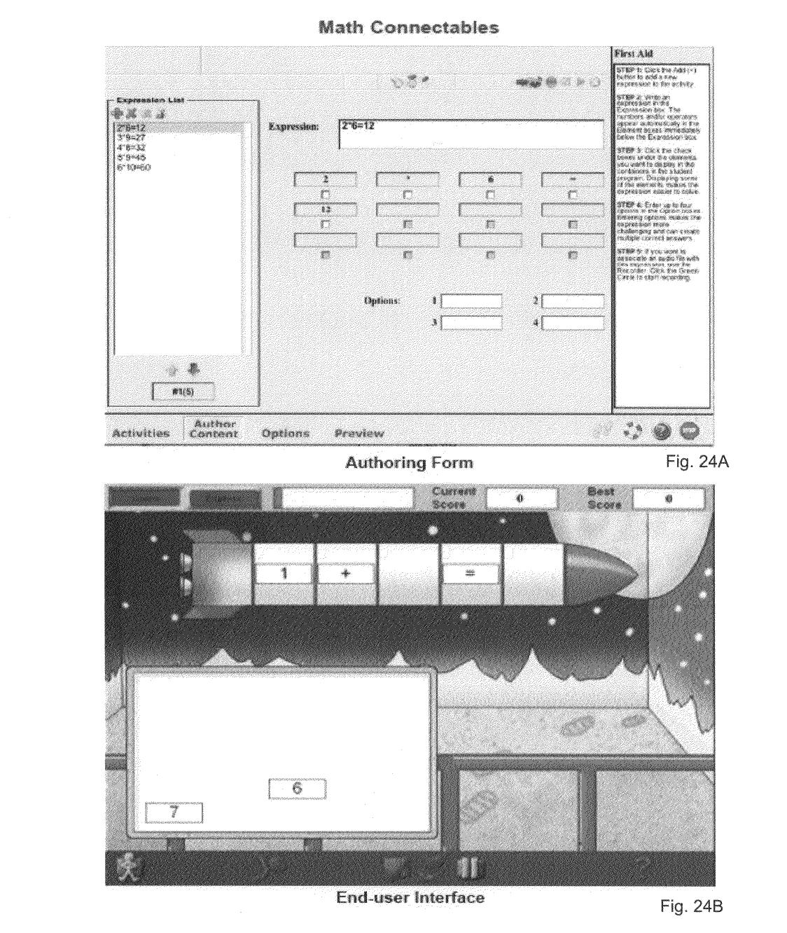

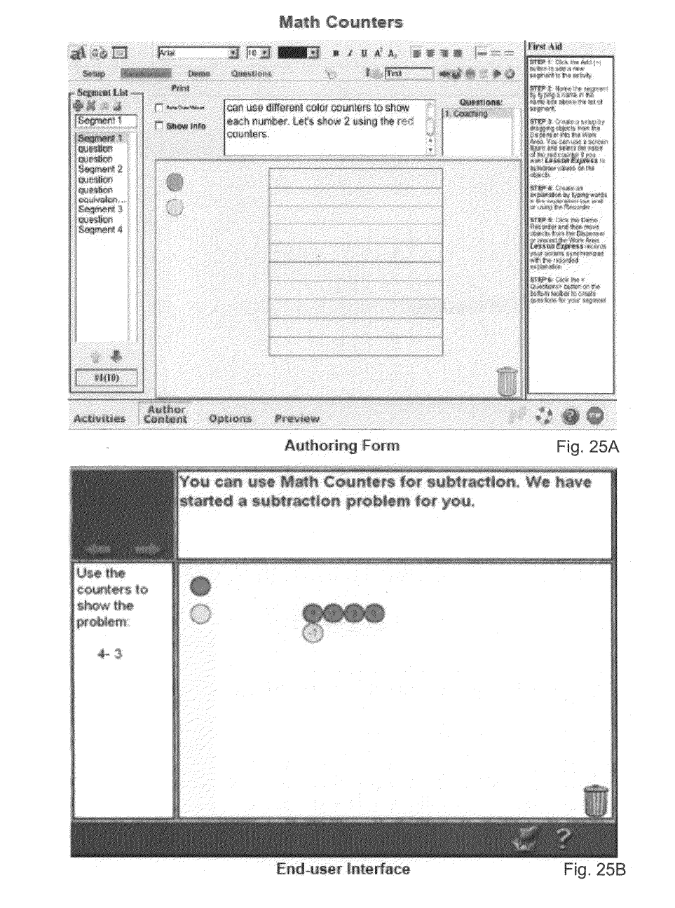

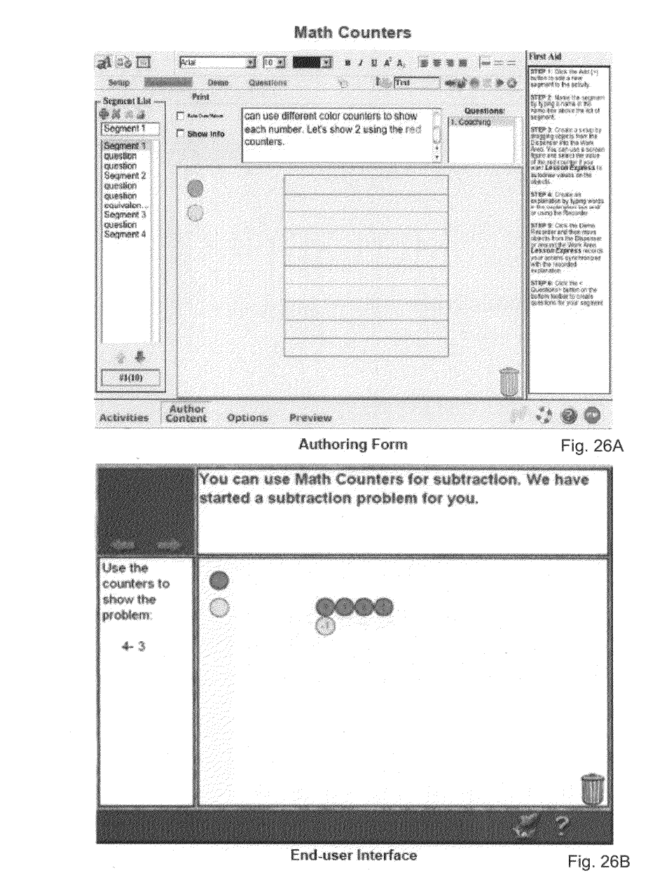

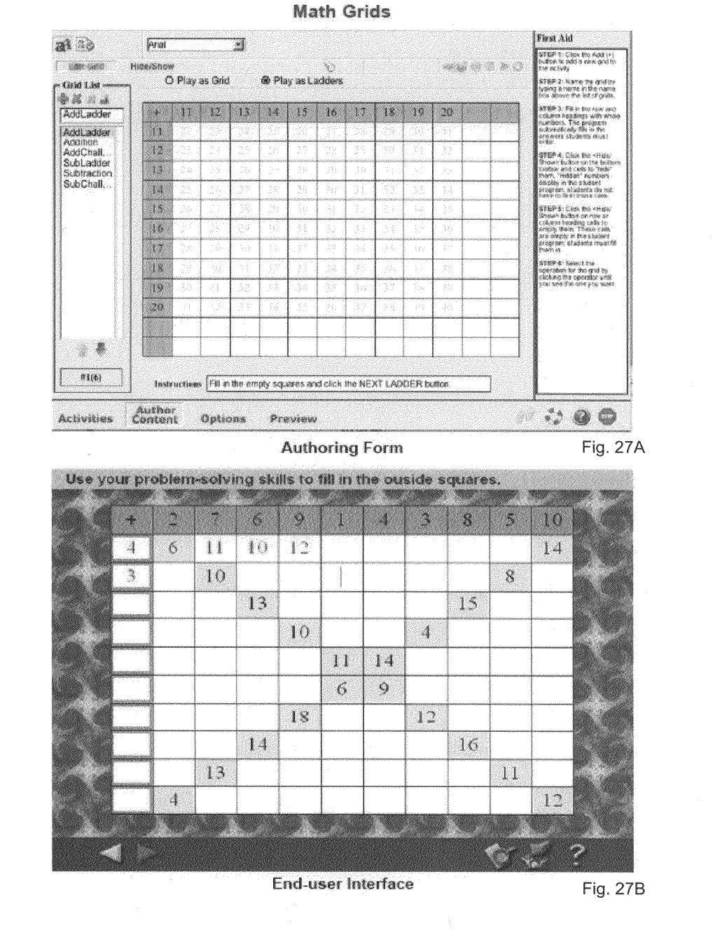

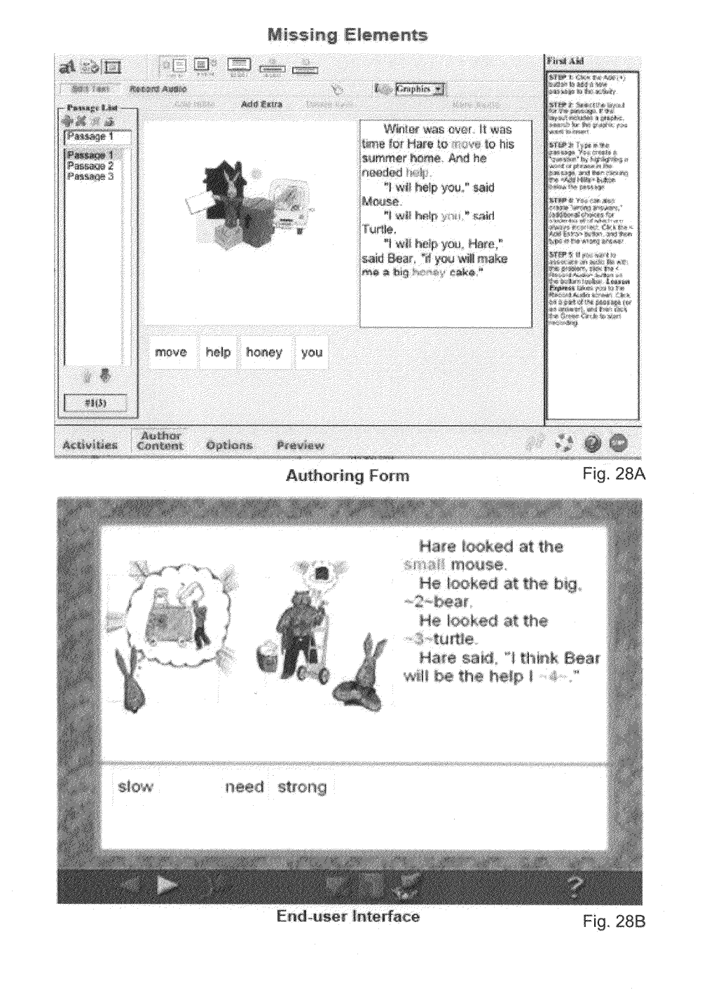

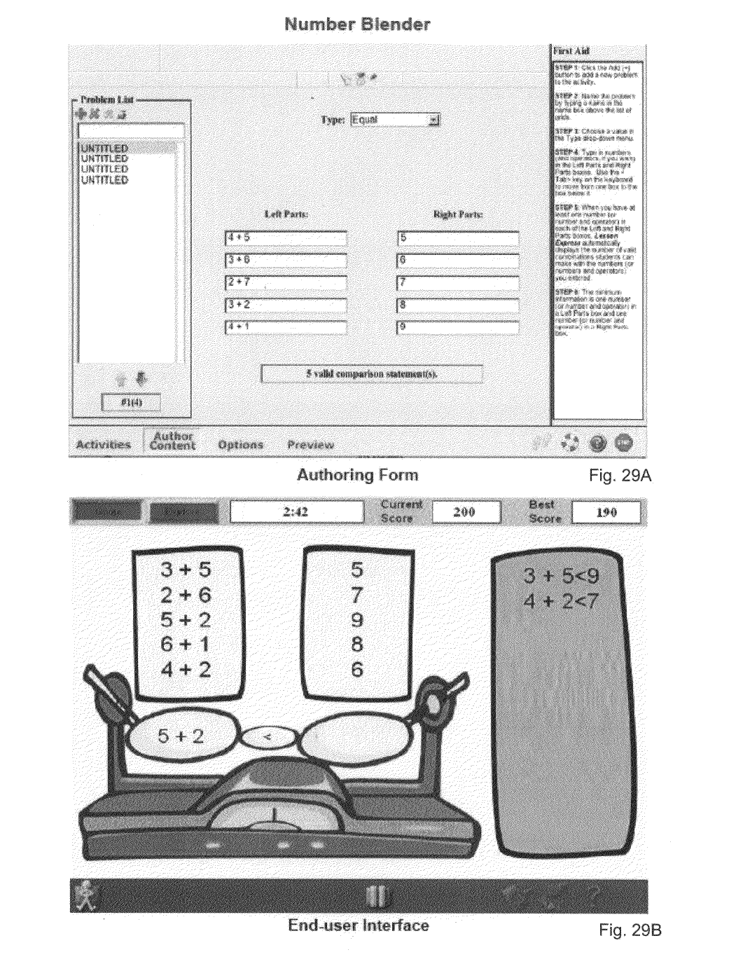

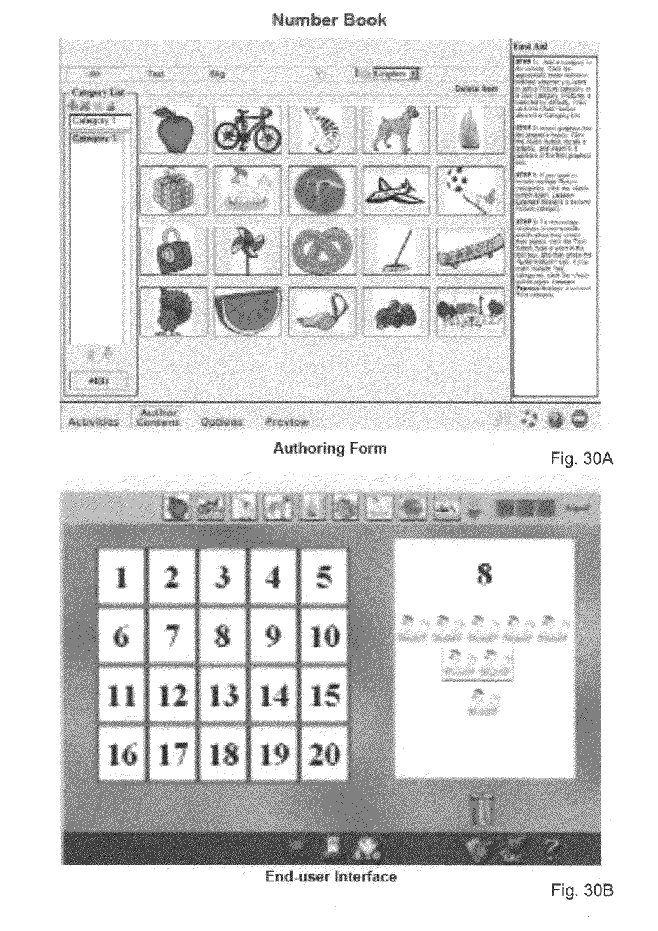

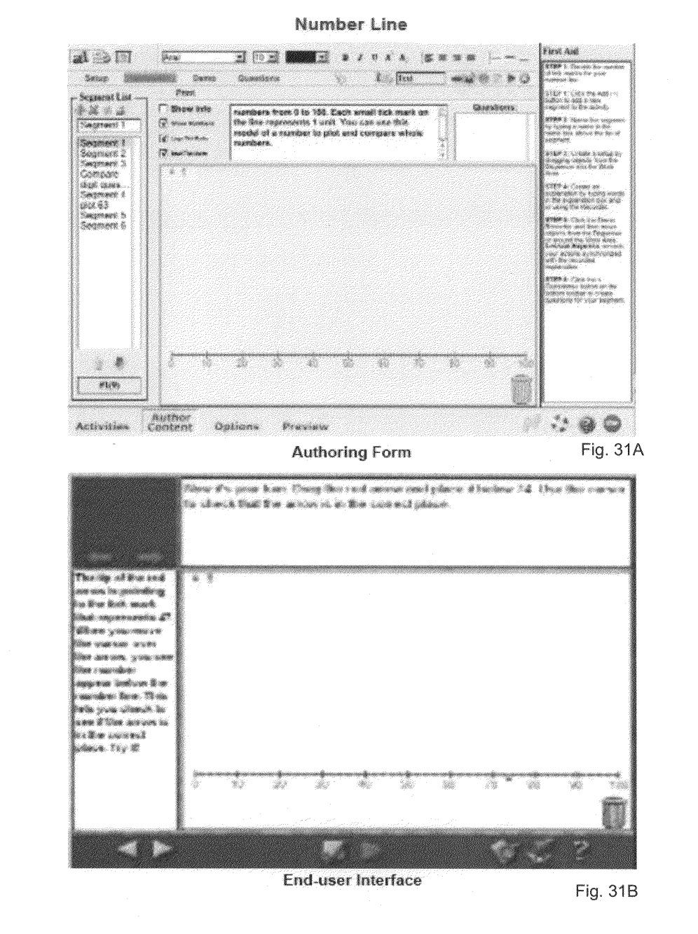

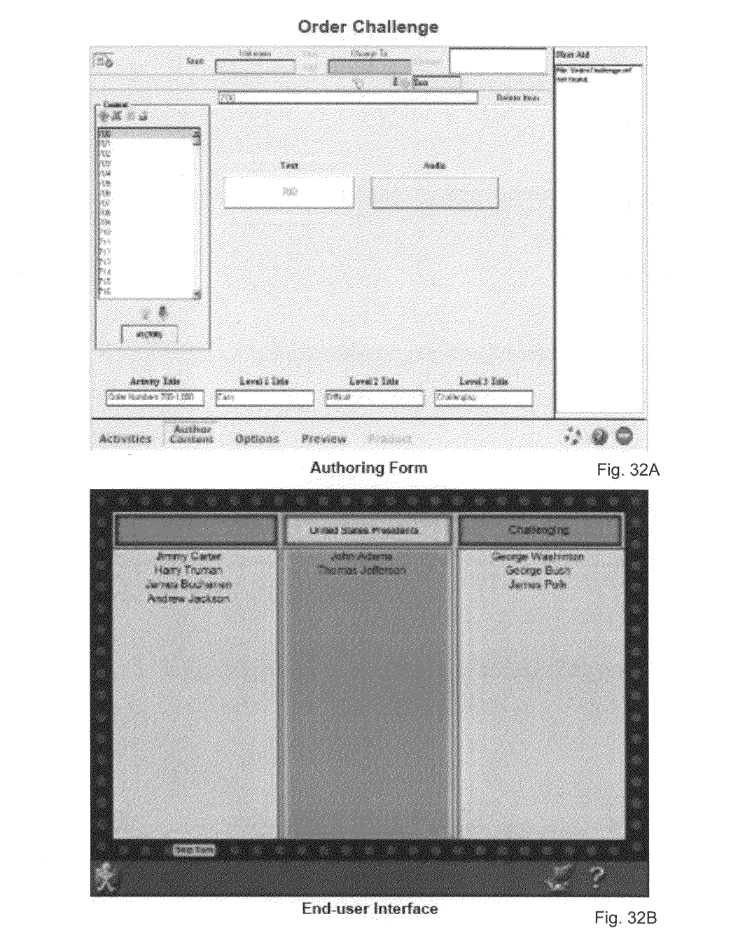

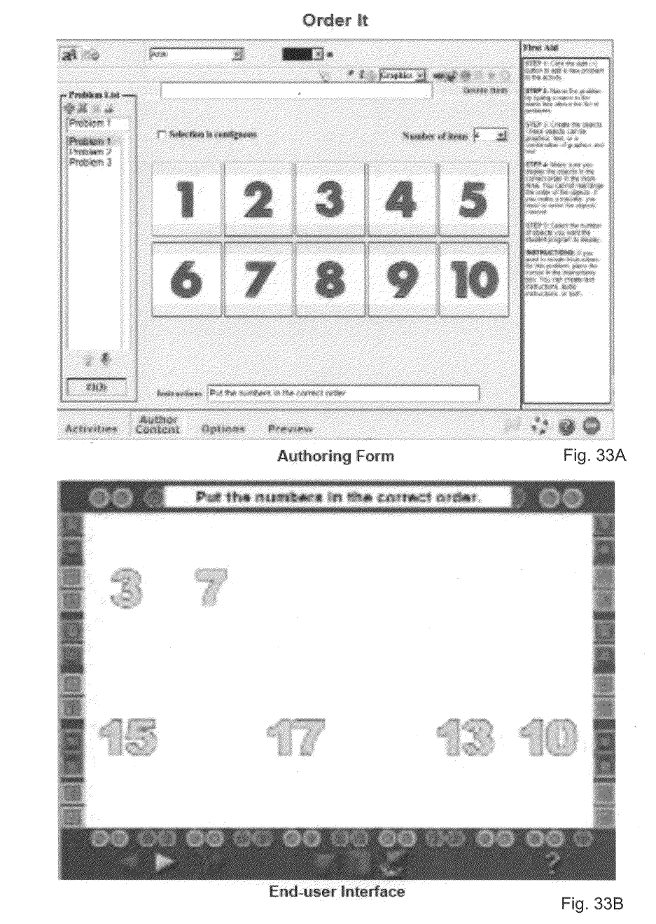

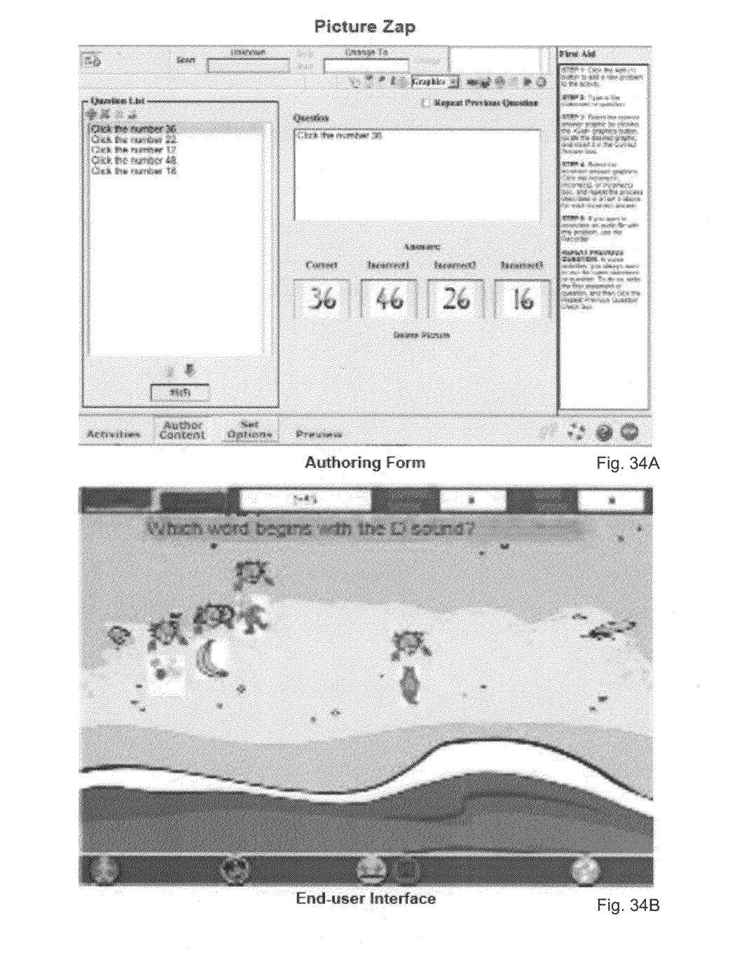

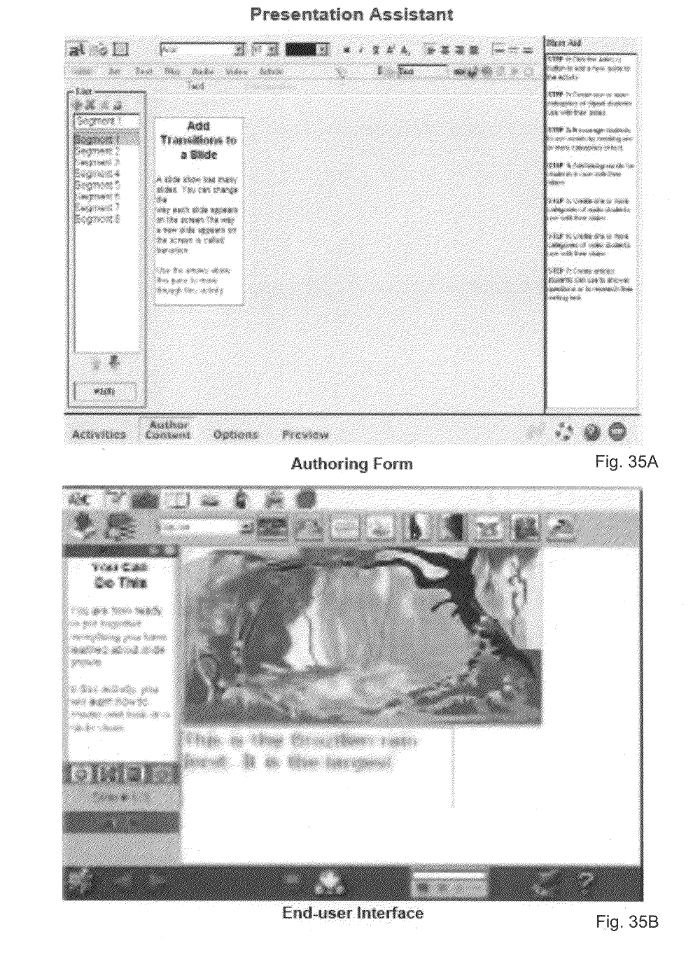

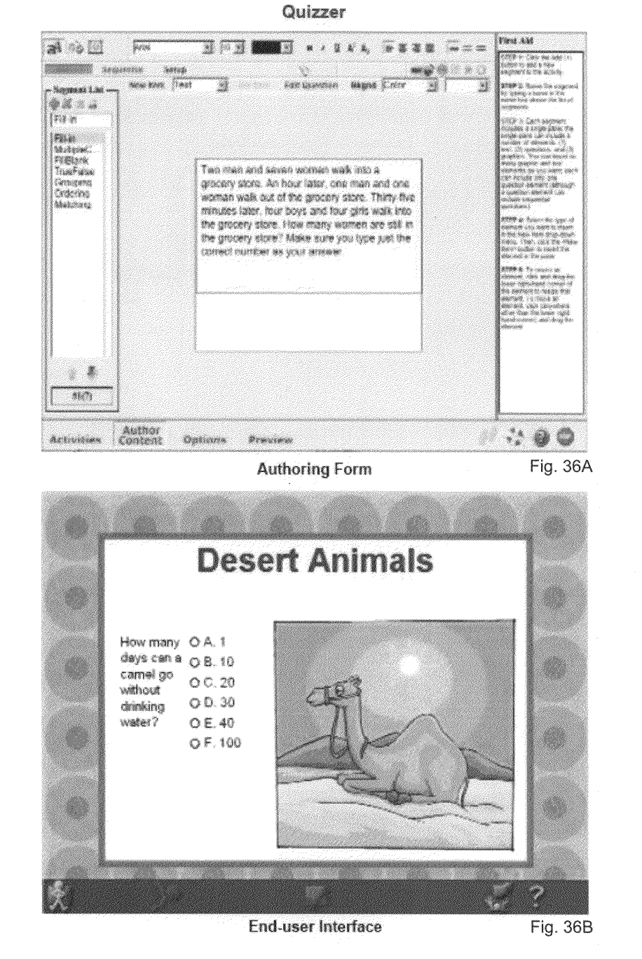

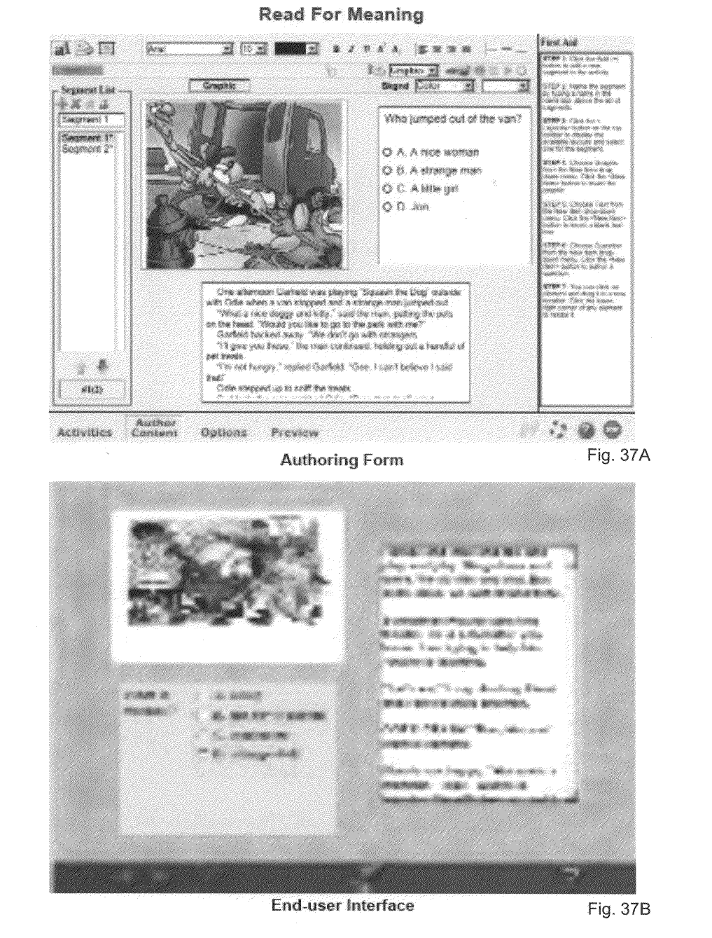

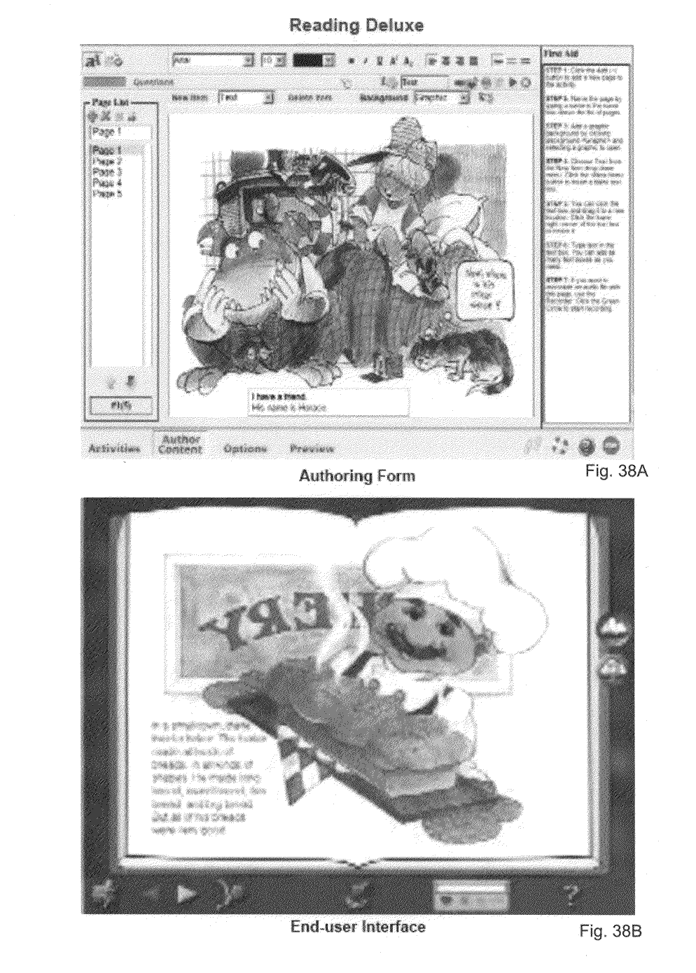

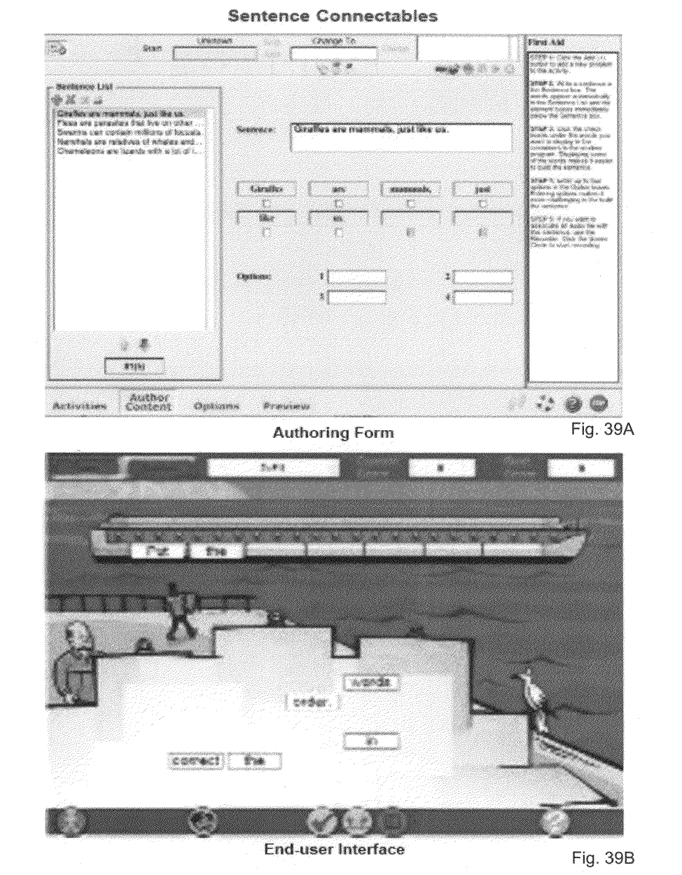

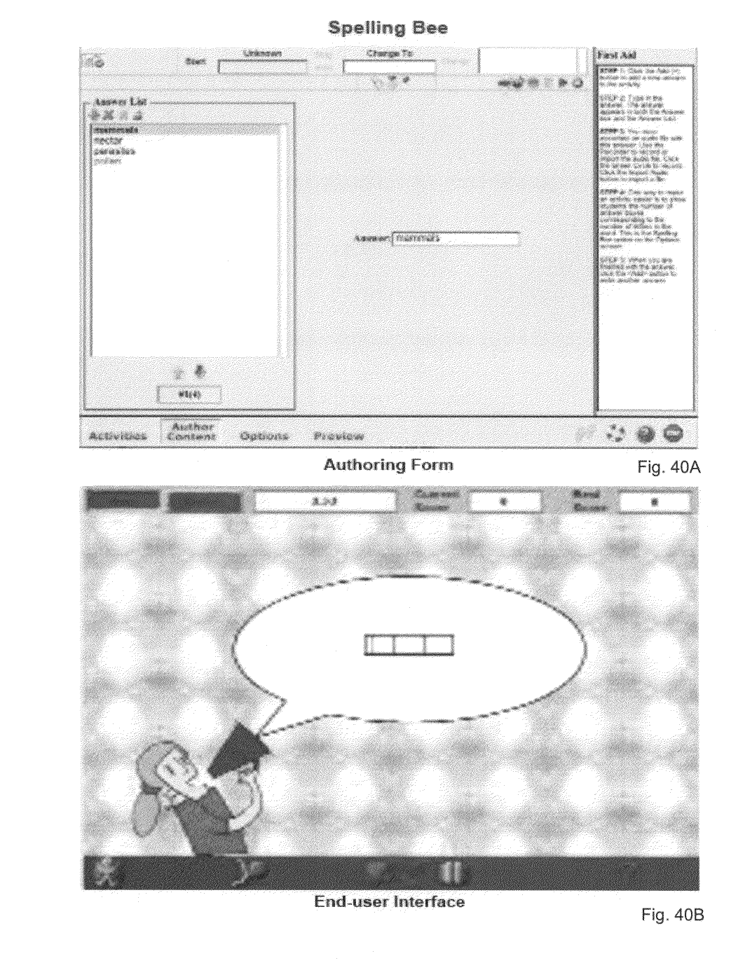

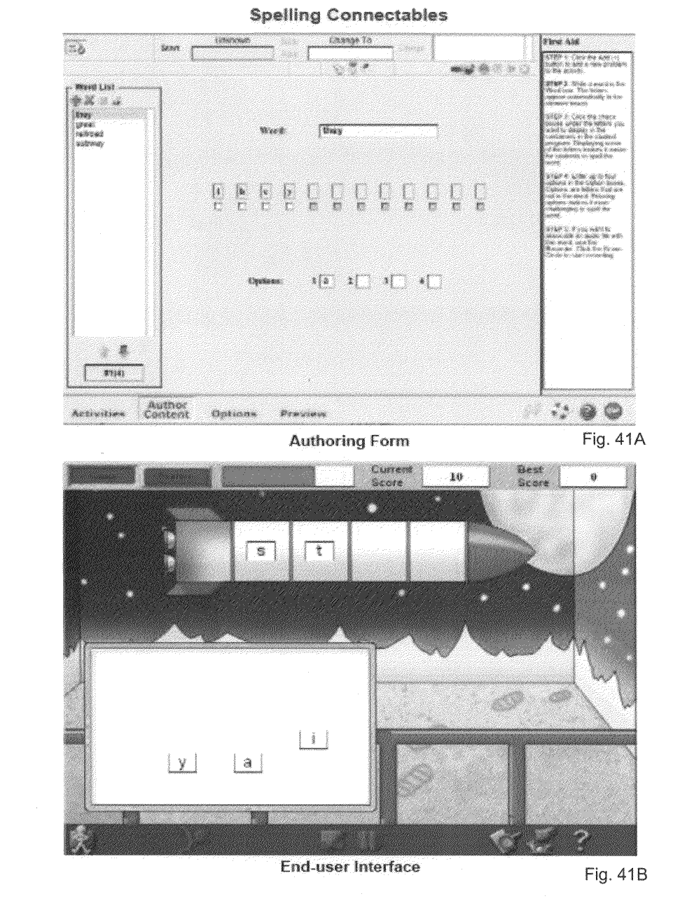

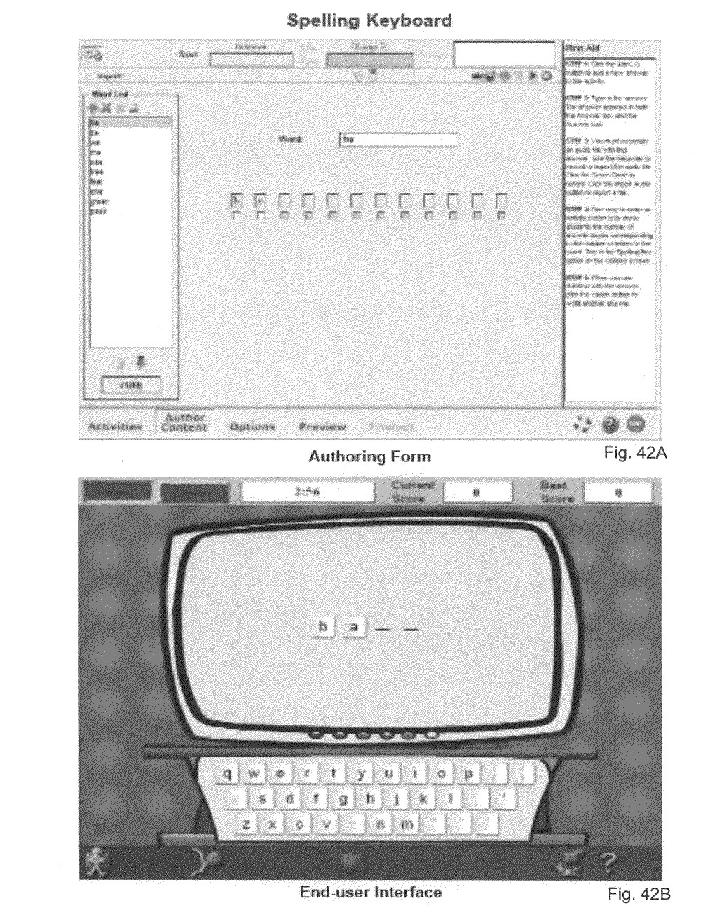

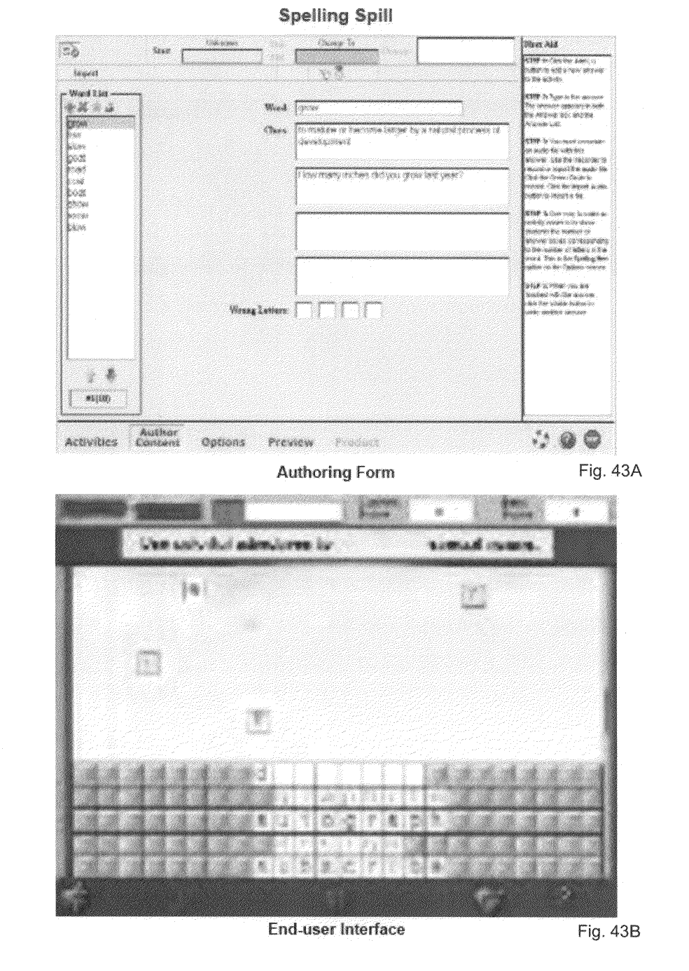

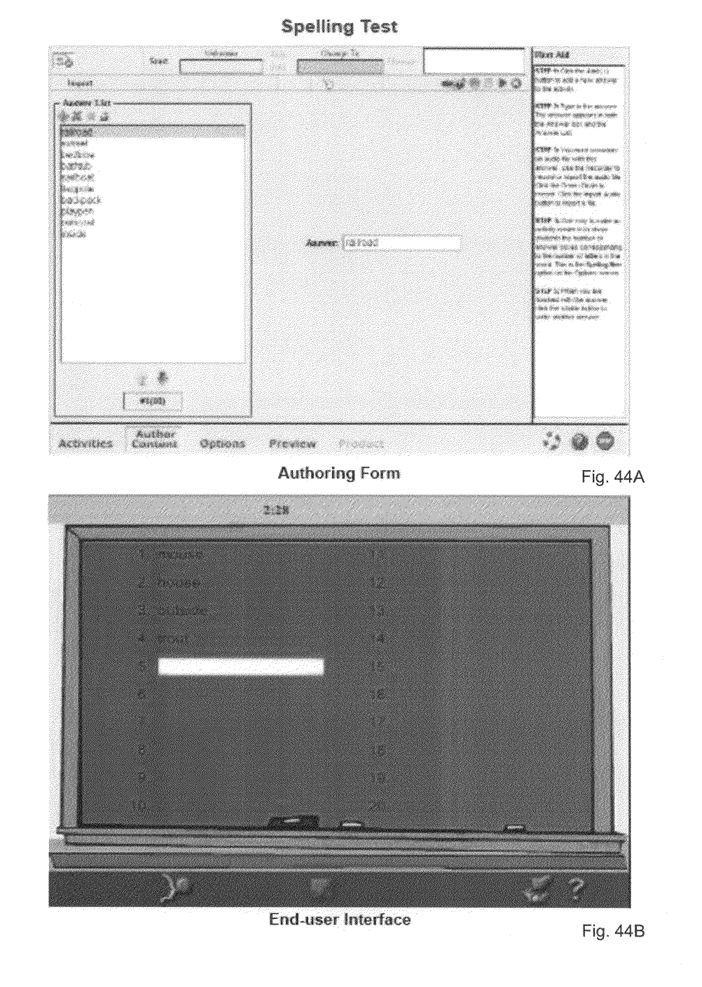

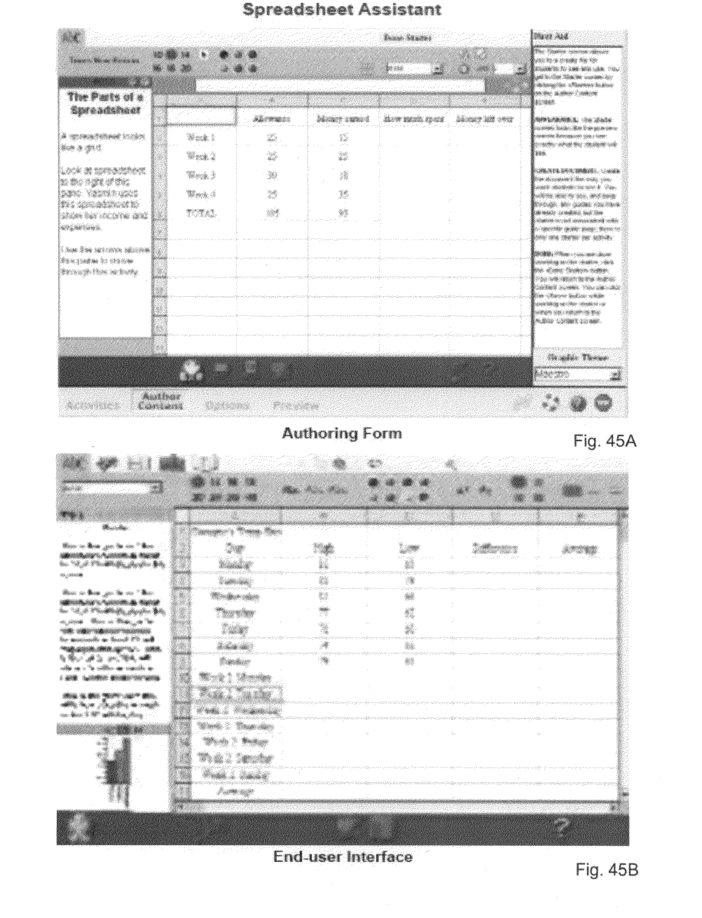

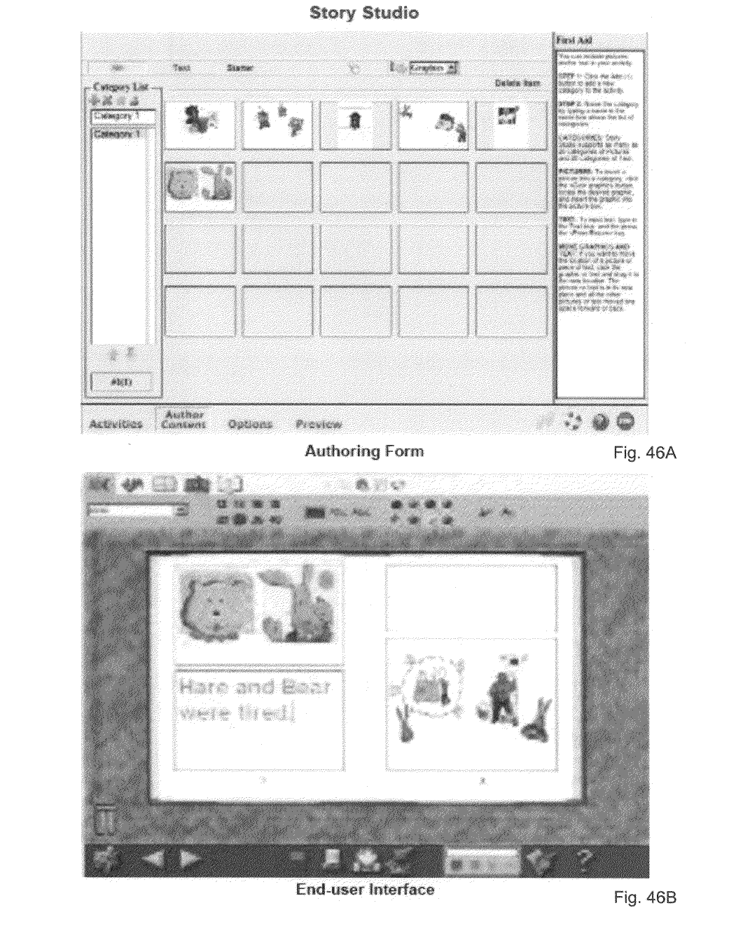

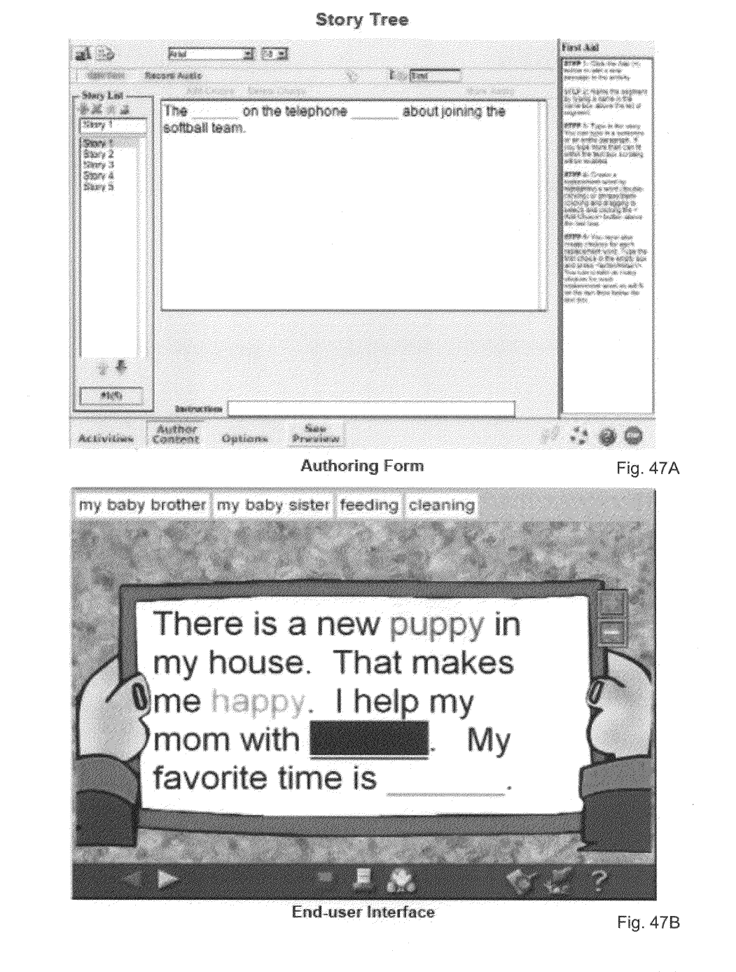

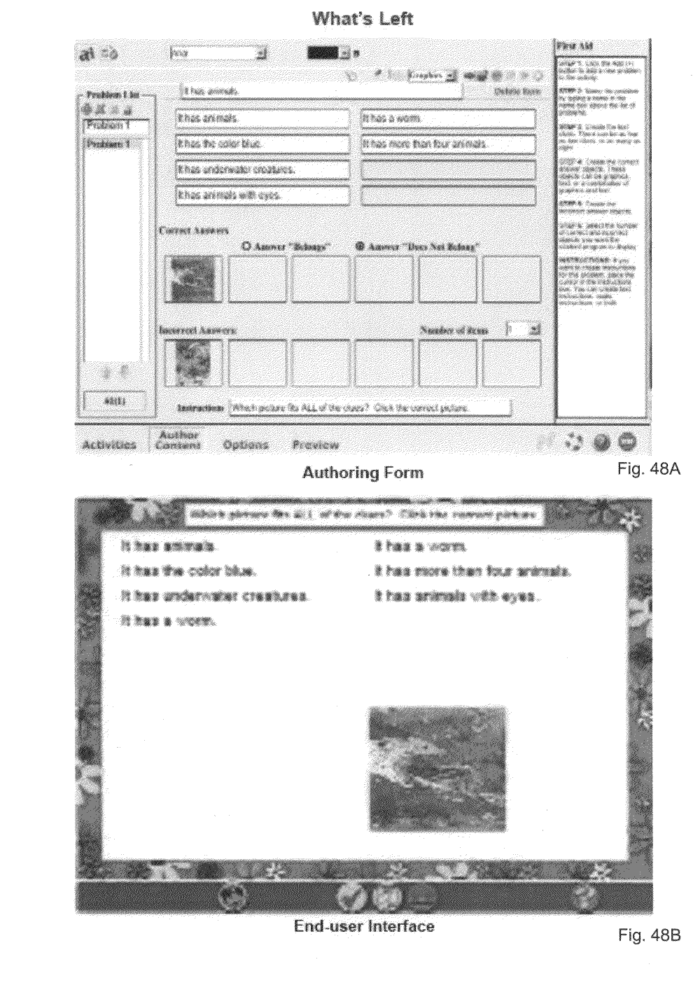

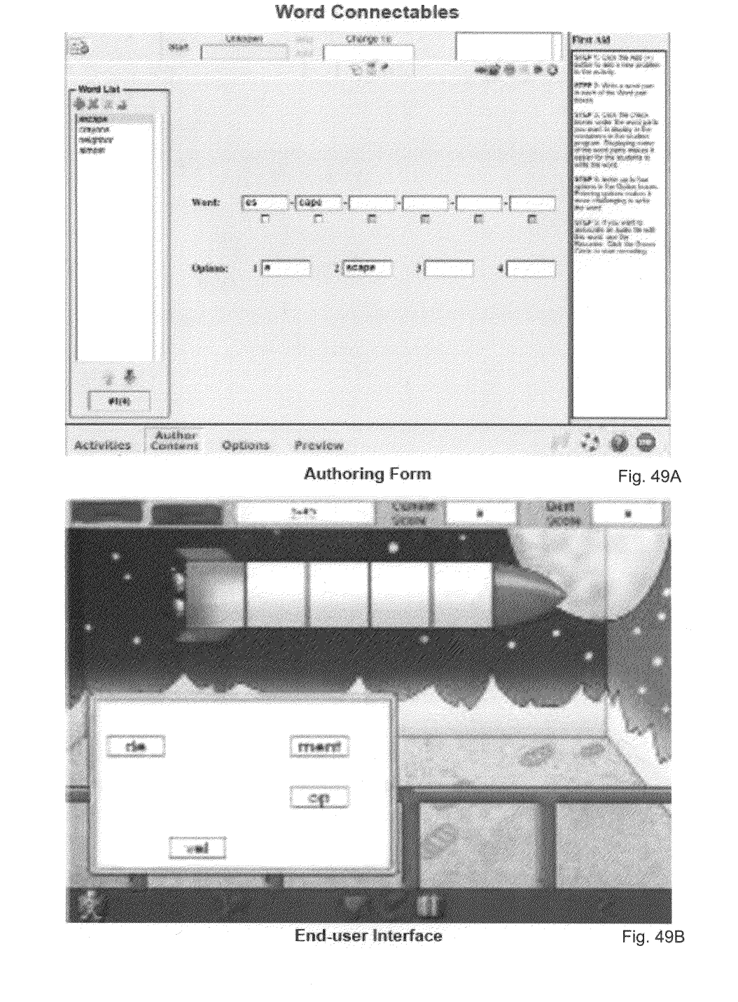

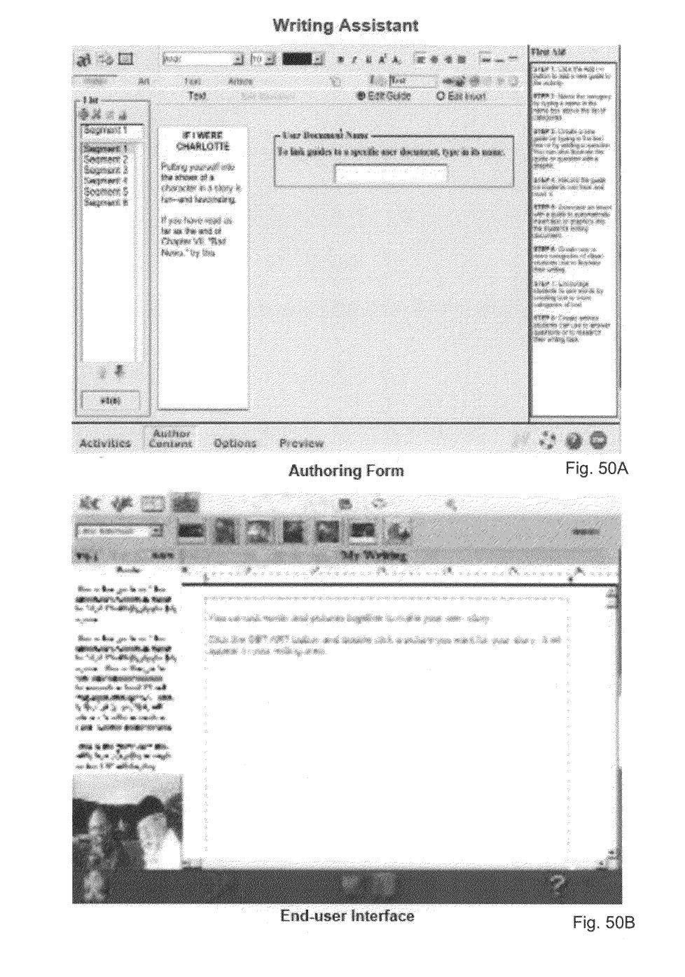

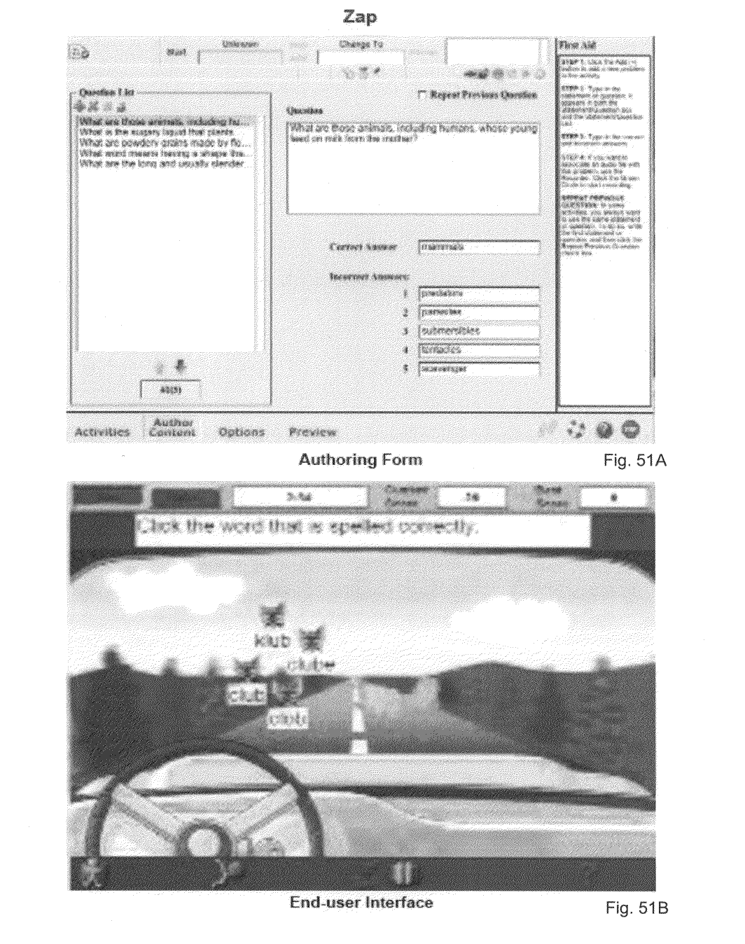

FIG. 2 schematically shows a process diagram depicting a method of generating, storing, and transmitting the interactive file created by the system 100. As mentioned above, the system generates/authors the interactive learning activity based on specifications and metadata provided by a user through one or more authoring forms. To that end, the system presents one or more authoring forms to the author and obtains specifications and metadata/attributes from the author (step 205). Exemplary authoring forms 300 are shown in FIGS. 3A to 51A. However, these authoring forms are for illustrative purposes only and are not intended to limit the scope of the present invention in any way.

In particular, the authoring forms 300 may include a variety of input fields that allow the user and/or creator to input information such as instructions 301, activity information and/or text 302, correct answers 303, incorrect answers 304, graphics 305, the number and type of cards and/or items within the activity 306, the type of question 307 (e.g., multiple choice, fill in the blank, etc.), backgrounds 308, and audio, to name but a few. It is important to note that the authoring forms 300 may be generic to all types of interactive activities (e.g., the same types of forms may be used for spelling activities, mathematics activities, matching activities, etc.) or each type of activity may have a topic-specific form, similar to what is shown in FIGS. 3A to 51A.

The authoring forms 300 may also include a listing of instructions 309 to the user/creator on how to use the authoring form 300 to create an activity. In other embodiments, the authoring forms 300 may also have a variety of other features such as a preview feature 311 that allows the user/creator to preview the final interactive learning activity. The preview feature 311 may allow the user/creator to simply view the interactive activity or play the activity. In embodiments in which the user can play the activity in the preview feature, the authoring/publishing module 110 can include a version of the player such that when the user/creator previews the activity, the player automatically launches and plays the activity.

While creating/authoring the interactive activity, the user/creator can assign attributes to each of the created activities. For example, the user/creator can assign attributes to the interactive activity such as grade level, subject, topic, skill, activity name, activity template family, activity template, language, status (e.g., private or public), and price, to name but a few. As will be discussed in greater detail below, these attributes can be later used to search for and select specific activities for download. The user/creator can also mark the interactive activity file as either “public” or “private.” While the activity file is marked “private,” only the original author or other authorized person (e.g., someone designated by the user/creator or the school district) can view and edit the activity file. However, once the activity file is marked as “public,” the activity file can be accessed (e.g., viewed, downloaded, played, etc.) by all teachers and/or parents.

Once the user/creator has completed the authoring forms 300 and provided attributes (e.g., metadata) for each of the created activities, the system 100 automatically generates the interactive activity learning file using the information provided through the authoring forms 300 by the user/creator (step 220). The attributes assigned to the activity will also be saved with the file, for example, as metadata so that that the activity can later be easily identified. As one may expect, the interactive learning file will include a number of end-user interface screens 350 through which the user/player will interact. Exemplary end-user interface screens 350 are shown in FIGS. 3B to 51B. However, these exemplary end-user interface screens 350 are for illustrative purposes only and are not intended to limit the scope of the present invention in any way. As can be seen from FIGS. 3B to 51B, the end-user interface screens 350 may vary in layout and content based on the type and subject matter of the activity and may include various types of active and inactive elements and effects, such as, for example, stationary pictures/designs, images, video, moving targets, selectable icons, control buttons, etc. Sounds/speech may be incorporated into the learning activities, e.g., by attaching audio files or performing text-to-speech conversion.

It should be noted that, in an exemplary embodiment, each of the activity files typically contains an XML file containing the activity information, a database file specific to the activity template, an options INI file, an activity specific help RTF file, an RTF file for the data, and graphics and audios file for the images and sounds contained within the activity.

Once the authoring/publishing module 110 creates the interactive learning activity file from the authoring forms 300, the authoring/publishing module 110 stores the interactive learning activity file on a database (step 220). The user may be provided with access to the files stored in the database via an on-line server (step 230). By storing the activity files on the user-accessible database, the user/creators are able to share their created learning activity files with others, e.g., school districts, parents, teachers, students, etc. A variety of database and on-line servers can be used to store the interactive activity files. For example, the system 100 may use an SQL server database. The SQL server database can reside on any internet service that supports SQL servers without any specific hardware requirements.

It should be noted that the interactive learning activity files created by embodiments of the present invention are stand alone files that are published to the database and may be individually downloaded so that, for example, the user is not required to download an entire CD-ROM. It should also be noted that in embodiments of the present invention, the interactive learning activity files are downloaded to the user's computer hard drive or other persistent storage as opposed to, for example, flash files that are stored transitorily in the web browser's cache.

When the user accesses the on-line database, the user may search for activity files contained within the database using the assigned attributes (e.g., the metadata) and select the activity files that they wish to download. The download module 120 may then transmit the selected activity files to the user's computer (step 240), typically after collecting payment for the selected activity files (e.g., by credit card, paypal, etc.). It should be noted that, in some embodiments, the files are completely transmitted to and downloaded by the user's computer such that they become physically stored on the user's hard drive. In such embodiments, the user does not need internet or on-line access to play the activity file at a later time.

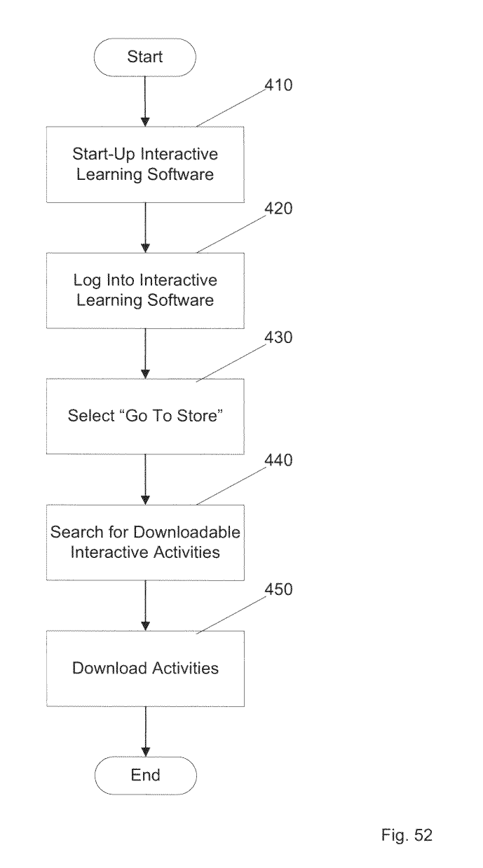

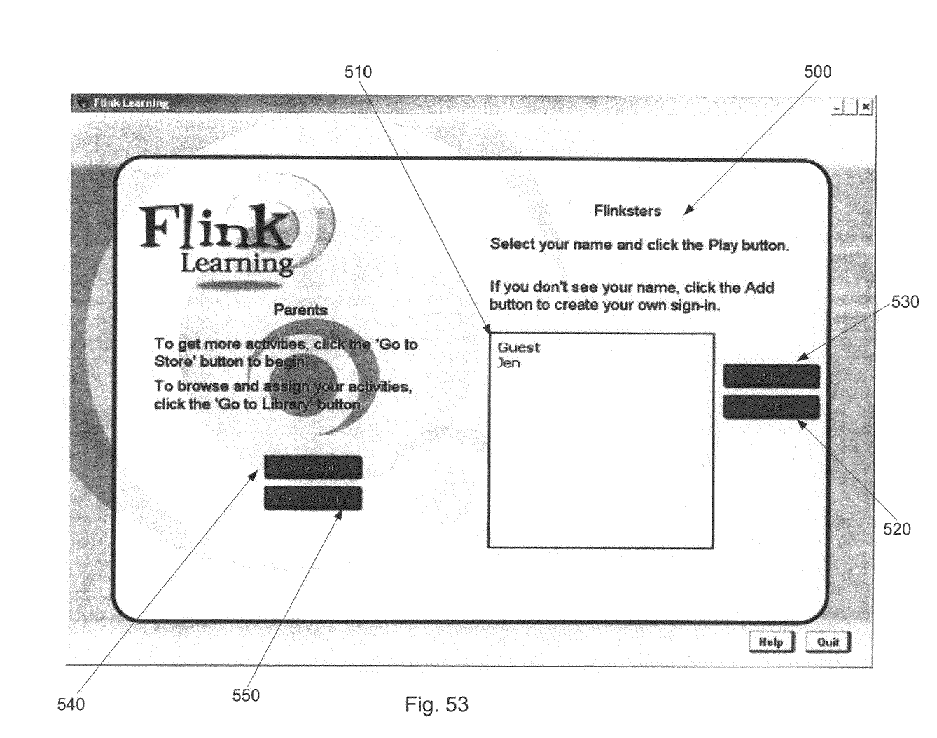

As discussed above, and as shown in FIG. 52, a user (either a creator of the activity files or someone else) can use the above described system 100 to download the interactive learning activity files created by the authoring/publishing module 110. To begin, the user starts up the interactive learning software package (Step 410) that may either be purchased on a CD-ROM or downloaded from a website. An exemplary start-up page 500 for the interactive learning software package is shown in FIG. 53.

Once at the start-up page 500, the user may log into the interactive software package (step 420), for example, by selecting their name from the list of authorized users 510. If the user's name is not shown on the list of authorized users 510, the user may either add their name using the add button 520 or they may select “guest” and log-in as a guest. If the user wishes to play a previously downloaded activity file, the user may select the “play” button 530 which launches the interactive activity player 130 and allows the user to play the activity.

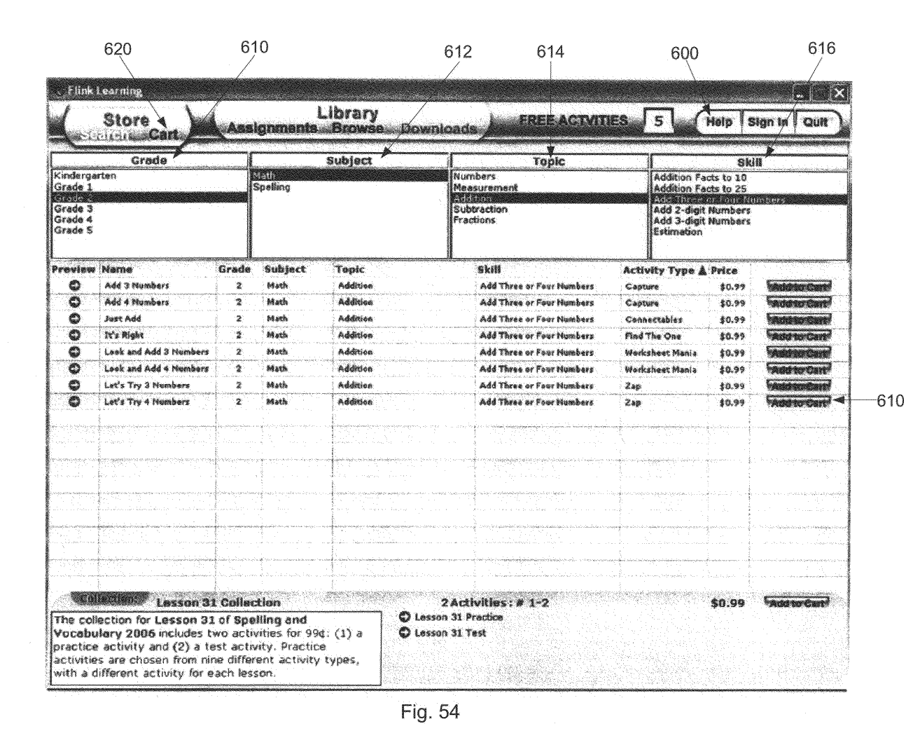

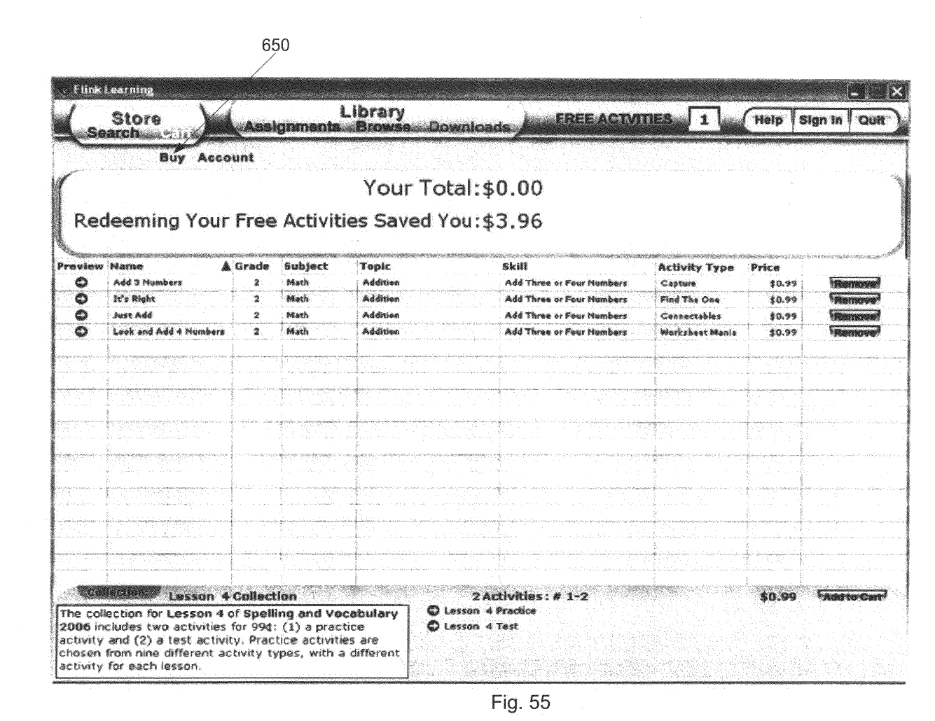

If the user wishes to download new and/or additional interactive activity files, the user may select the “go to store” button 540 (step 430), which brings the user to a search screen 600. FIG. 54 shows an exemplary search screen 600. At the search screen 600, the user can search for downloadable interactive activity files (step 440) that the authoring/publishing module 110 stored within the on-line database discussed above. As shown in FIG. 54, the search screen 600 may include a number of search fields that correspond to the attributes and metadata assigned to the activity file by the creator. For example, the search screen 600 may have a grade search field 610, a subject search field 612, a topic search field 614, and a skill search field 616. As the user selects the desired search criteria listed below each search field, the system 100 will display the search results, including information relating to each of the search results (e.g., the attributes assigned to the activity file, price, etc.). The user may then select the activity files that they wish to download by selecting the “add to cart” button 610. By doing so, the activity file will be added to their cart.

At any time, the user may view his or her cart, which contains the selected activity files waiting to be downloaded, by pressing the “cart” button 620 located at the top left side of FIG. 54. As shown in FIG. 54, the cart displays the activity files that the user has selected to add to the cart, along with the activity file information (e.g., the attributes and metadata), the price, and the total cost of the files within the cart (with any potential savings or discounts). If the user wishes to purchase the activity files saved in the cart, the user need only press the “buy” button 650. When the user presses the “buy” button 650, the download module 120 transmits the selected activity files to the user's computer (e.g., the user downloads the files) (step 450).

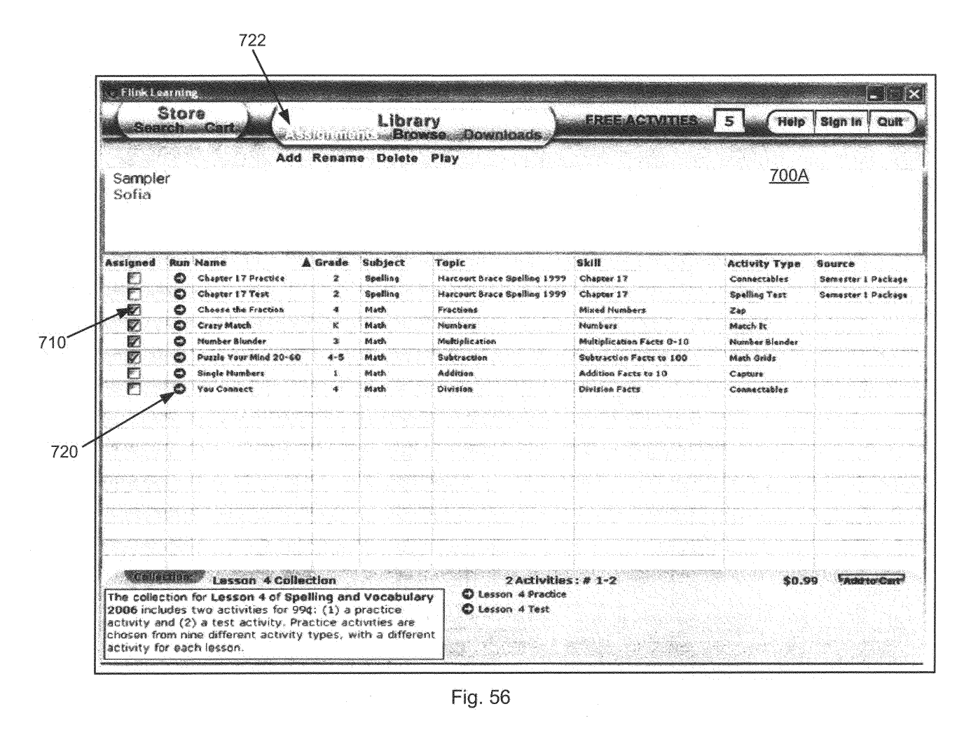

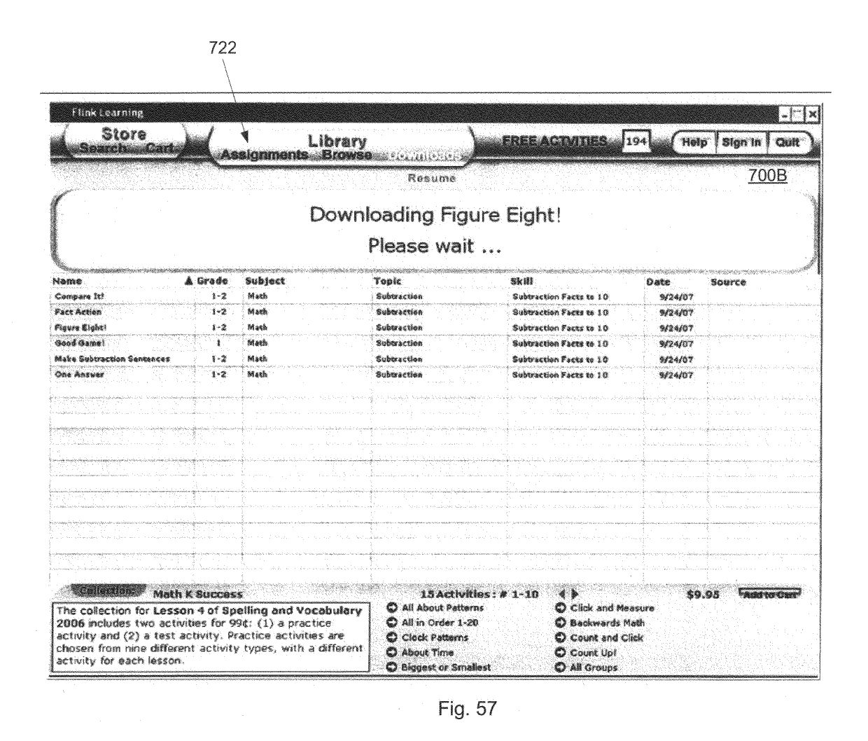

Returning to FIG. 53, in addition to playing and shopping for activity files, the user may also view and/or organize previously downloaded activity files by pressing the “go to library” button 550. By pressing the “go to library” button, the user is taken to the user's library of previously downloaded activities. FIGS. 56 and 57 show exemplary library screens 700A and 700B. As can be seen in FIGS. 56 and 57, the library screens 700A and 700B list the downloaded activity files and the corresponding attribute information (e.g., name, grade level, subject, topic, skill, activity type, source, etc.).

As mentioned above, the user may use the library pages 700A and 700B to view and organize activity files. Additionally, a parent or teacher can assign certain activities or create an assignment list for a student or a class. To do so, the parent or teacher need only select the “assign” button next to the appropriate activity file, and an assignment list containing the selected files is automatically created. A teacher or a parent is permitted to assign specific activities to an entire class, groups of students within the class, or to an individual student. While in the library screens 700A/B, the user can view the activities within an assignment by selecting the “assignment” button 722 located near the top of the library screen 700A/B. The user may also add, rename, delete or play any the activity files by pressing the “add” button 712, the “rename” button 714, the “delete” button 716, or the “play” button 718, respectively. As an alternative to the “play” button 718, the user can also run the activity file by pressing the “run” icon 720 located next to the individual activity file.

After the parent or teacher has created the assignments for the student(s), the student(s) may then log-on at a later time, as described above. The student can play the activities that were assigned by selecting the “play” button 530, FIG. 53, which launches the activity player 130. Further, once the students have played the activities, the system 100 can generate and send a report to the teacher(s) and/or parent(s) indicating how the student performed on the activities.

Embodiments of the invention may be implemented as a computer program product for use with a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may either be a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer systems (e.g., on system ROM or fixed disk), or distributed from a server or electronic bulletin board over the network (e.g., the Internet or World Wide Web).

Although the above discussion discloses various exemplary embodiments of the invention, it should be apparent that those skilled in the art can make various modifications that will achieve some of the advantages of the invention without departing from the true scope of the invention.

What is claimed is:

1. A method of authoring a downloadable interactive learning activity, the method comprising:
generating, by a first subsystem of an interactive learning activity authoring system, an interactive learning activity computer file based on learning activity specifications received via a series of computer-based learning activity authoring forms; and
storing, by a second subsystem of the interactive learning activity authoring system, the learning activity file and associated metadata in a database that is accessible via an online server.

2. A method according to claim 1, wherein the metadata includes at least one of grade level, subject, topic, skill, activity name, activity template family, activity template, language, public/private status, and price.

3. A method according to claim 1, further comprising:
presenting the computer-based learning activity authoring forms via a user interface; and
receiving the learning activity specifications via the user interface.

4. A system for authoring a downloadable interactive learning activity, the system comprising:
a first subsystem for generating an interactive learning activity computer file based on learning activity specifications received via a series of computer-based learning activity authoring forms; and
a second subsystem for storing the learning activity and associated metadata in a database that is accessible via an online server.

5. A system according to claim 4, wherein the metadata includes at least one of grade level, subject, topic, skill, activity name, activity template family, activity template, language, public/private status, and price.

6. A system according to claim 4, further comprising:
a user interface for presenting the computer-based learning activity authoring forms and for receiving the learning activity specifications.

7. A system according to claim 4, further comprising an interactive activity player permitting authors to preview their interactive learning activities prior to publication.

8. A method of distributing a downloadable interactive learning activity, the method comprising:
providing access to a database of interactive learning activity computer files via an online server, the online server allowing a user to search for and selectively download interactive learning activity computer files based on metadata associated with the interactive learning activity computer files; and
transmitting selected interactive learning activity computer files for storage on a user computer, whereby the downloaded interactive learning activity computer files can be played on the user computer without online access.

9. A method according to claim 8, wherein the metadata includes at least one of grade level, subject, topic, skill, activity name, activity template family, activity template, language, public/private status, and price.

10. A system for distributing a downloadable interactive learning activity, the system comprising:
a database of interactive learning activity computer files, wherein the database is accessible via an online server, the online server allowing a user to search for and selectively download interactive learning activity computer files based on metadata associated with the interactive learning activity computer files; and
a download module for transmitting selected interactive learning activity computer files for storage on a user computer, whereby the downloaded interactive learning activity computer files can be played on the user computer without online access.

11. A system according to claim 10, wherein the metadata includes at least one of grade level, subject, topic, skill, activity name, activity template family, activity template, language, public/private status, and price.

12. A system according to claim 10, further comprising a web server on which the download module runs.

13. A system according to claim 10, further comprising an interactive activity player permitting interactive learning activities to be played over a network.
